(19) United States
(12) Patent Application Publication
(10) Pub. No.: US 2008/0201385 A1
(43) Pub. Date: Aug. 21, 2008

(54) METHOD AND SYSTEM FOR COLLECTING USER UPDATE REQUESTS REGARDING GEOGRAPHIC DATA TO SUPPORT AUTOMATED ANALYSIS, PROCESSING AND GEOGRAPHIC DATA UPDATES

(75) Inventors: Mark S. Winberry, Hanover, NH (US); Christopher Gross, Hanover, NH (US); Tyler Charles Brown, East Thetford, VT (US); Roger W. Brown, West Lebanon, NH (US); Jennifer Parker-Laflamme, Manchester, NH (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 11/928,091

(22) Filed: Oct. 30, 2007

Related U.S. Application Data
(63) Continuation of application No. 11/831,816, filed on Jul. 31, 2007.
Application No. 11/831,816 is a continuation of application No. 11/772,771, filed on Jul. 2, 2007.
(60) Provisional application No. 60/817,895, filed on Jun. 30, 2006.

(51) Int. Cl. G06F 17/30

(52) U.S. Cl. 707/200; 707/E17.018

(57) ABSTRACT

A system and method provide functionality for collecting user update reports of geographic inconsistencies between geographic data and the real world to enable automated processing of updates to the geographic data. A user's input is collected and describes an anomaly, which is a geographic inconsistency between geographic data and the real world. The user's input is stored as language neutral structured data that enables automated processing of updates to the geographic data. Automatic processes that process the structured data include an email agent, an incident agent, a geographic augmentation agent, a case generation agent, a clustering agent, an automatic validation agent, and a monitoring service. Automatic and manual processes combined together handle processing of anomalies, as well as other related processing, and ultimately handle processing of updates to the geographic data to resolve the anomalies reported by the users.

### CLAIM OF PRIORITY

This application is a continuation of U.S. patent application Ser. No. 11/831,816 entitled “METHOD AND SYSTEM FOR COLLECTING USER UDPATE REQUESTS REGARDING GEOGRAPHIC DATA TO SUPPORT AUTOMATED ANALYSIS, PROCESSING AND GEOGRAPHIC DATA UPDATES,” by Winberry, et al., filed Jul. 31, 2007, which is a continuation of U.S. patent application Ser. No. 11/772,771 filed Jul. 2, 2007, entitled “METHOD AND SYSTEM FOR COLLECTING USER UPDATE REQUESTS REGARDING GEOGRAPHIC DATA TO SUPPORT AUTOMATED ANALYSIS, PROCESSING AND GEOGRAPHIC DATA UPDATES,” which claims priority to U.S. Provisional Patent Application 60/817,895 filed Jun. 30, 2006, entitled “METHOD AND SYSTEM FOR COLLECTING USER UPDATE REQUESTS REGARDING GEOGRAPHIC DATA FROM VARIOUS SOURCES TO SUPPORT AUTOMATED ANALYSIS, PROCESSING AND FEEDBACK,” each of which is hereby incorporated by reference.

### COPYRIGHT NOTICE

A portion of the disclosure of this patent document contains material which is subject to copyright protection. The copyright owner has no objection to the facsimile reproduction by anyone of the patent document of the patent disclosure, as it appears in the Patent and Trademark Office patent file or records, but otherwise reserves all copyright rights whatsoever.

### BACKGROUND OF THE INVENTION

1. Field of the Invention

The present invention relates to geographic databases, and more particularly, to collection of real-world geographic information to update data in geographic databases.

2. Description of the Related Art

In recent years, consumers have been provided with a variety of devices and systems to enable them to locate specific geographic locations on a digital map, as well as to navigate streets, roads and boat routes by means such as vehicles, bicycles, boats and by foot. These devices and systems are in the form of in-vehicle navigation systems, portable hand-held devices such as personal digital assistants (PDAs), personal navigation devices and cell phones that can do the same, and Web applications. The common aspect in all of these and other types of devices and systems is a geographic database of geographic features and software to access and manipulate the geographic database in response to user inputs. Essentially, in all of these devices and systems a user can enter a target place and the returned result will be the location of the target place. Typically, users will enter an address, the name of a business, such as a restaurant, a city center, or a destination landmark, such as the Golden Gate Bridge, and then be returned the location of the requested place, or feature. The location can be shown on a map display, or can be used to calculate and display driving directions to the location, or used in other ways.

In viewing geographic data using these systems and devices, users may come across geographic data that is incorrect or incomplete. While viewing a map display, the user may notice that data is missing, misnamed, misplaced, is shown but does not actually exist, or is otherwise incorrect. Similarly, while viewing or listening to driving directions on a system or device, the user may notice that geographic data is incorrect if the directions are incorrect for some reason. “There is a new subdivision at this location” is an example of missing data. “The new street name is Flanders Lane” is an example of misnamed data. “There is no left-turn restriction here” is an example of data shown that does not actually exist.

These errors are often caused because changes that are continuously occurring in the real world may not be reflected in the user's geographic database. Sometimes these errors are due to a mistake in the map maker's source data or procedures used in making the map. Sometimes these errors are due to software that interprets the geographic database if the software has an error or cannot interpret a particular combination of geographic data. In any event, as part of his ongoing business, the map maker is continuously working to improve the geographic database and offer newer versions with errors corrected. The map maker has many sources and techniques for correcting errors and updating the maps. Some of these sources and techniques are: collecting updates from local governments who know about or control changes in their community, on-location data capture generated by map maker personnel dedicated to such activities, analysis of overhead photographs collected for mapping and other purposes, and update requests from end users who happen by errors as they use products that have the map maker's map. In the past, map makers have provided end users with ways to give them information about errors.

Currently, users of applications utilizing geographic databases, when encountering such data omissions or errors, have to rely on communicating the problem that they notice to the application or geographic data vendor and have to describe the problem in their natural language based on their understanding of the implementation of the data and the location of the error. These systems collect unstructured data from end users, in particular with regard to the type and the location of issue being described. This lack of structure means that the user update requests must he processed by humans, and as such, does not easily scale to high volumes.

What is needed is an Web based collection system by which an end user can easily report useful information about incorrect geographic data in a structured way, in order for the map maker to update his proprietary geographic database with correct and timely geographic data. The system must be highly available to the user. The end user must be encouraged to submit actionable data or data that is useful. Actionable data is not “garbage,” or incomplete data and/or data that is not complete enough to take meaningful actions. The user must be enabled to show where a map related problem is located and to classify the problem. However, required inputs and free-form language should be avoided as much as possible in order to limit noisy or incorrect user update requests, and thus prevent pollution of valuable data. At the same time, the user must be allowed to type in correct, useful information where it can be so expressed.

What is needed is a system that constrains the user to express the problem in a set of finite, unambiguous problem descriptions, so that the user-entered information is stored as structured data, that can be automatically processed instead of manually processed. Because there can be millions of end users using data that covers many countries all over the world, what is needed is an automated means for processing very large quantities of end user update requests, as well as a loosely coupled, distributed system to provide scaling to high volumes of data. Further, what is needed is a collection system that is localizable where language is concerned so that it can work with end users from all over the world. The system should allow the end user to enter information about incorrect geographic data so that the entered data does not have a dependency on language translation or interpretation. Thus, what is needed is one set of structured data types for processing worldwide user-entered information.

What is needed is a toolset to allow the end user supplied data to be transformed into information to guide proprietary database production processes and business planning processes in order to further the goal of accurate and timely geographic data. The toolset should interface with existing business processes to provide information to support confirmation or modification of current business and operational practices and priorities. Preferably, the toolset reduces the cost structure of operations by interfacing with existing operations processes to efficiently present actionable issues to workflow systems.

Finally, what is needed is a method of communicating back to the end user regarding the status of the user's submission, as well as reports that can be run to determine the status of user submissions.

### SUMMARY OF THE INVENTION

A system and method provide functionality for collecting user update reports of geographic inconsistencies between geographic data and the real world to enable automated processing of updates to the geographic data. A user's input is collected and describes an anomaly, which is a geographic inconsistency between geographic data and the real world. The user's input is stored as language neutral structured data that enables automated processing of updates to the geographic data. Automatic processes that process the structured data include an email agent, an incident agent, a geographic augmentation agent, a case generation agent, a clustering agent, an automatic validation agent, and a monitoring service. Automatic and manual processes combined together handle processing of anomalies, as well as other related processing, and ultimately handle processing of updates to the geographic data to resolve the anomalies reported by the users

### BRIEF DESCRIPTION OF THE DRAWINGS

Further details of the present invention are explained with the help of the attached drawings in which:

FIG. 1 illustrates of an example overview of the customer feedback loop (CFL) system, according to embodiments;

FIG. 2 shows an example Web application flowchart for allowing end users and partners to submit geographic data anomaly information in the CFL front end, according to embodiments;

FIG. 3 shows an example “Welcome” page of the Web application, according to embodiments;

FIG. 4 shows an example table of country names and corresponding country codes used with the “Welcome” page of FIG. 3, according to embodiments;

FIGS. 5A and 5B show example “Where” pages of the Web application, according to embodiments;

FIGS. 6A and 6B show example “What” pages of the Web application, according to embodiments;

FIG. 7 shows an example set of anomaly types for the example “What” page of FIG. 6A, according to embodiments;

FIG. 8 shows a further example set of anomaly types for the actions and objects on the “What” pages of FIGS. 6A and 6B, according to embodiments;

FIG. 9 shows an example “Verify” page of the Web application, according to embodiments;

FIG. 10 shows an example “Acknowledgment” page of the Web application, according to embodiments;

FIG. 11 illustrates an example high level view of the page flow described in the Web application flowchart of FIG. 2, according to embodiments;

FIG. 12 illustrates an example front end of the customer feedback loop (CFL) according to embodiments;

FIG. 13 shows an example table of map place form variables used with the place find service of the CFL front end, according to embodiments;

FIG. 14 shows an example table of map location form variables used with the map service of the CFL front end, according to embodiments;

FIGS. 15A and 15B show an example list of anomaly parameters accepted by the anomaly collection service of the CFL front end, according to embodiments;

FIG. 16 illustrates an example back end of the customer feedback loop (CFL) according to embodiments;

FIG. 17 shows an example anomaly group report provided by the anomaly browser application of the CFL back end, according to embodiments;

FIG. 18 shows an example screen of the anomaly browser application of the CFL back end, according to embodiments;

FIG. 19 shows example statuses of anomalies, according to embodiments; and

FIG. 20 shows an example flow chart of the end user feedback process, according to embodiments.

### DETAILED DESCRIPTION OF THE INVENTION

### Overview

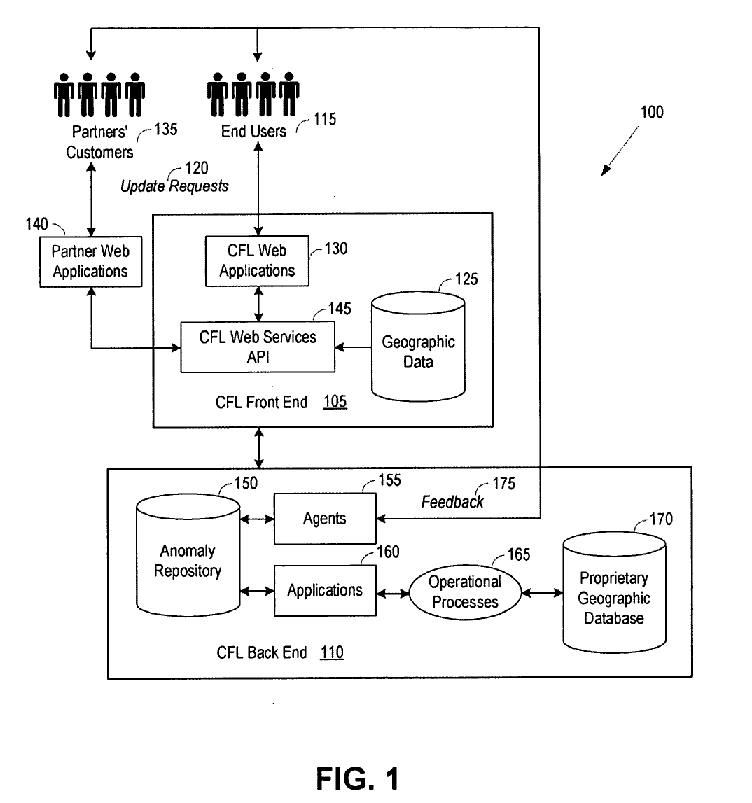

FIG. 1 illustrates an example overview of the customer feedback loop (CFL) system 100, according to embodiments. The system includes a CFL front end 105 and a CFL back end 110. The system includes web applications which allow end user customers, shown as end users 115, to submit update requests 120 regarding discrepancies in data in a current version of geographic data 125 to a proprietary website, shown as CFL Web applications 130. These data discrepancies include incorrect data and data omissions. Business partner manufacturers of devices, systems and applications, as well as their end user customers, shown as partners' customers 135, can also submit similar update requests 120 through the website of the partner, shown as partner Web applications 140. Both partner Web applications 140 and CFL Web applications 130 utilize the CFL Web service application program interface (API), shown as CFL Web services API 145.

Throughout this description, the terms “end user” or simply “user” includes end user customers, business partners, and business partner end user customers. In embodiments, the CFL Web applications 130 and Partner Web applications 140 are not limited to Web applications and can be simply applications. For convenience, the term “Web application” will be used through this description to reference both Web applications and applications. The Web applications and Web services API allow the user to describe the type and location of a map discrepancy in a structured format referred to as an “anomaly.”

These Web applications can be accessed using any of a variety of devices and systems, including but not limited to, in-vehicle navigation systems, portable hand-held devices such as personal digital assistants (PDAs), personal navigation devices and cell phones that can do the same, personal computers, and laptops.

Anomalies are transferred from the CFL front end 105 to the CFL back end 110, where they are stored in the anomaly repository 150 and analyzed both by autonomous agents 155 and by applications 160 operating under human control. In general, applications 160 work with proprietary operational processes 165 to update geographic data in a new version of the proprietary geographic database 170. At various points during the update workflow, the agents 155 can send feedback 175 to an end user 115, 135 informing him or her of changes in the status of the user's reported anomaly. After the user completes entering an anomaly, and the applications 160 and operational processes 165 determined that information regarding the anomaly should be updated, the proprietary geographic database 170 is updated with correct information related to the anomaly. The geographic data 125 is periodically updated with data from the proprietary geographic database 170.

Once updated geographic data 125 is available to the CFL Web services API 145, agents 155 can send feedback 175 to the end user 115, 135 requesting that the user provide feedback on the data update using a CFL Web application 130. At this point, the system has received and acted on the end user's update request and has verified, via the original end user, that the anomaly has been addressed in geographic data 125.

### Starting the Process: Collecting End User Update Requests

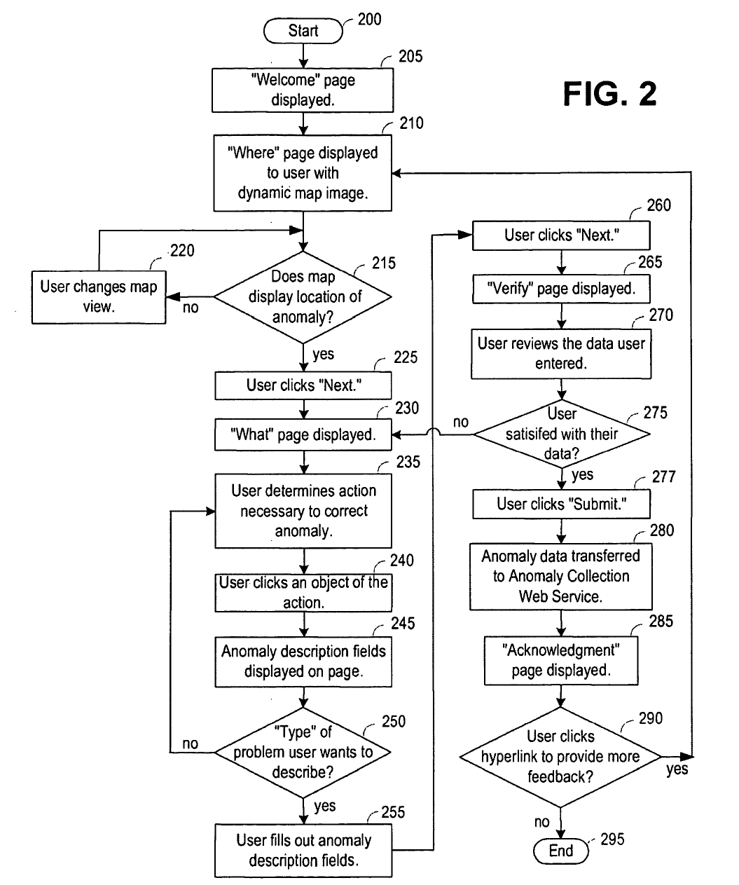

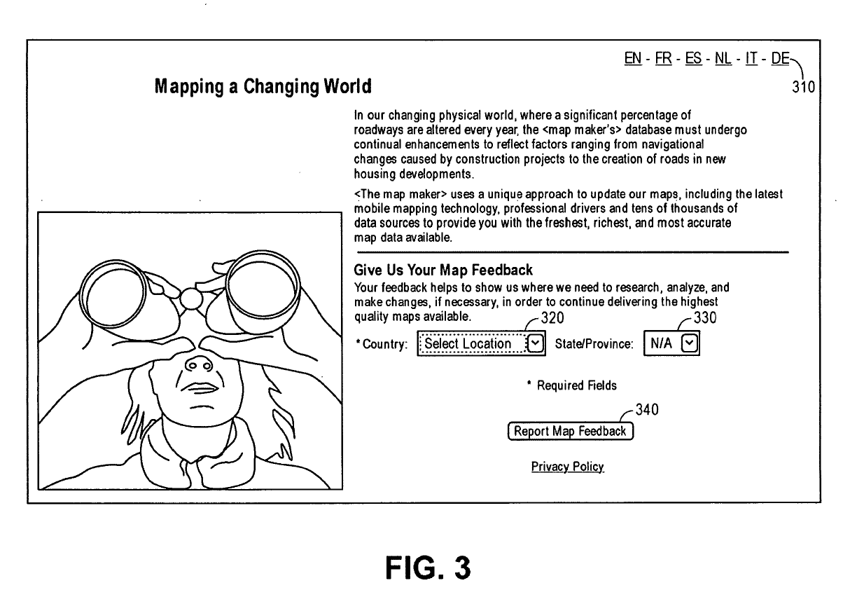

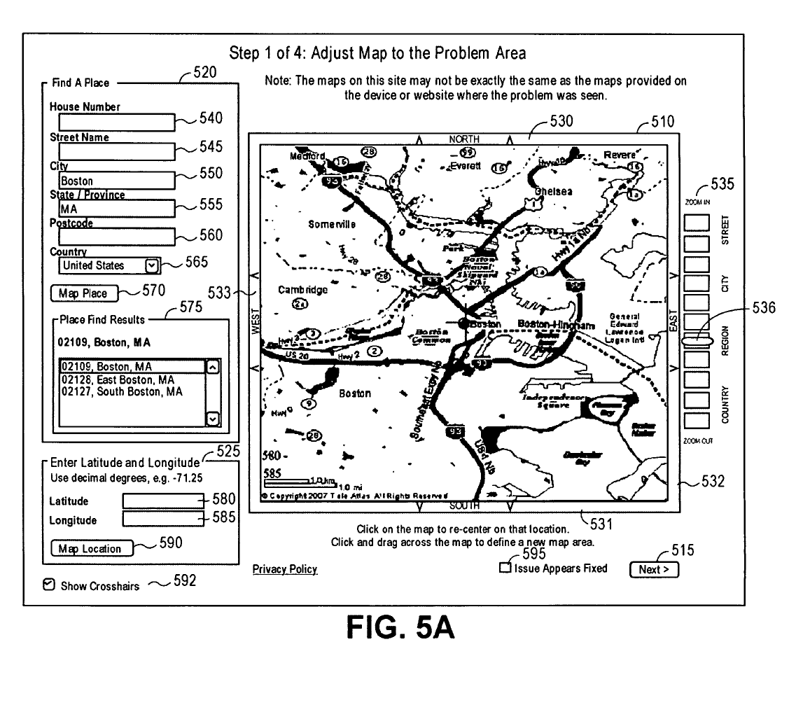

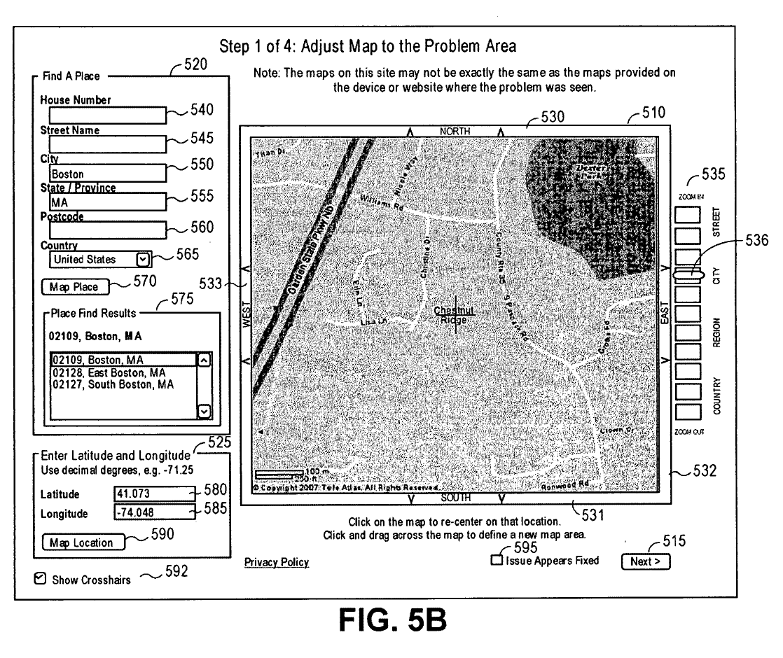

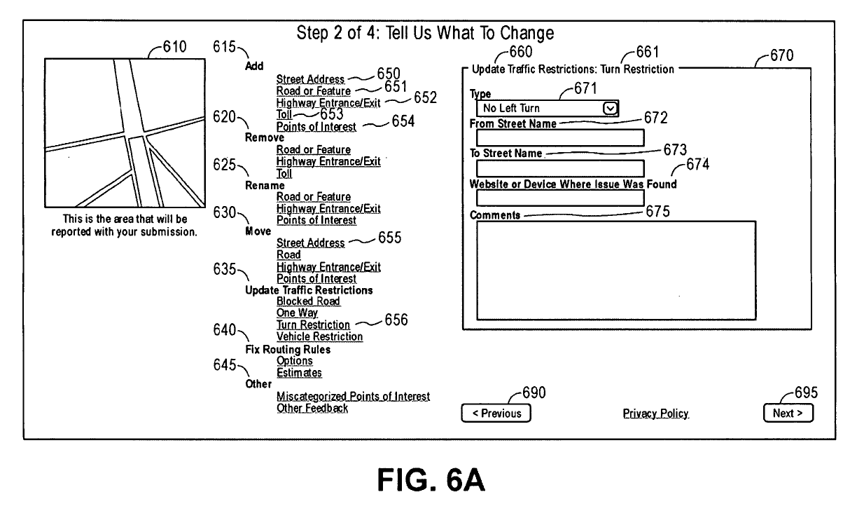

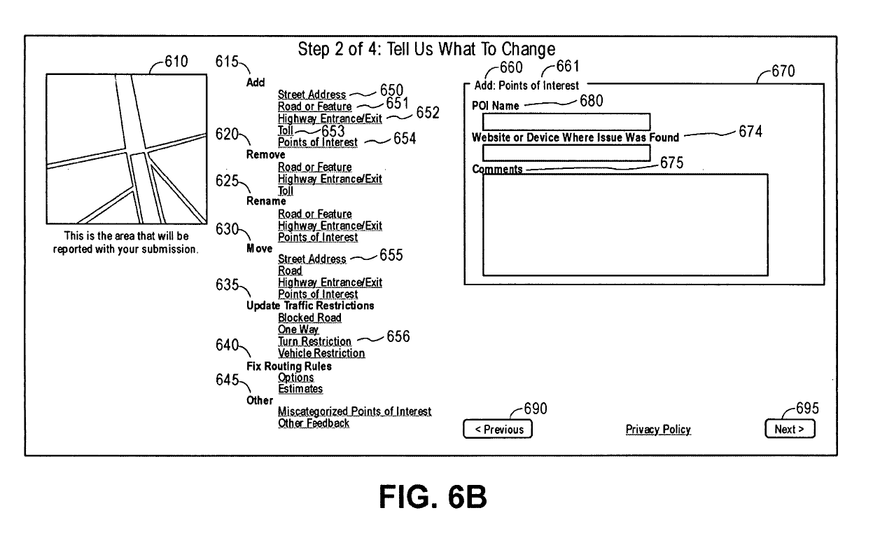

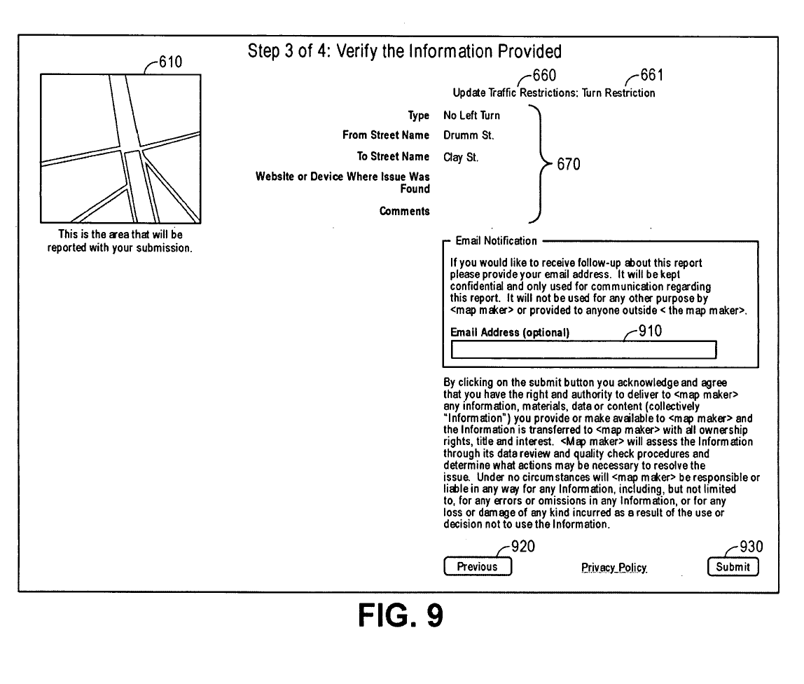

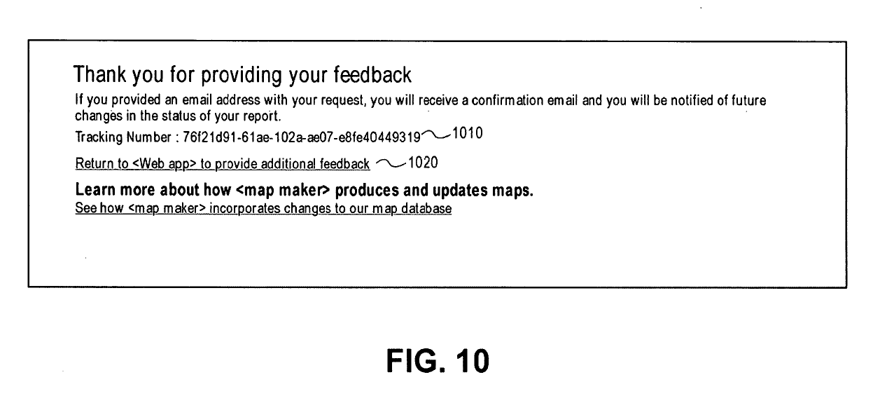

FIG. 2 shows an example Web application flowchart for allowing end users and partners to submit geographic data anomaly information in the CFL front end, according to embodiments. The Web application includes five main pages, including a “Welcome” page shown in FIG. 3, a “Where” page shown in FIGS. 5A and 5B, a “What” page shown in FIGS. 6A and 6B, a “Verify” Page shown in FIG. 9, and an “Acknowledgment” page shown in FIG. 10.

Two key elements of this flow create the anomaly location and type. For the anomaly location, user map navigation creates the map display specifying the geographic extent of the problem. For the anomaly type, the Web application assists the user in describing the type of problem that should be corrected in the map maker's database. In addition to anomaly location and type, the user can enter supplemental information describing the corrected information, for example, the correct name of a misnamed street and arbitrary user comments.

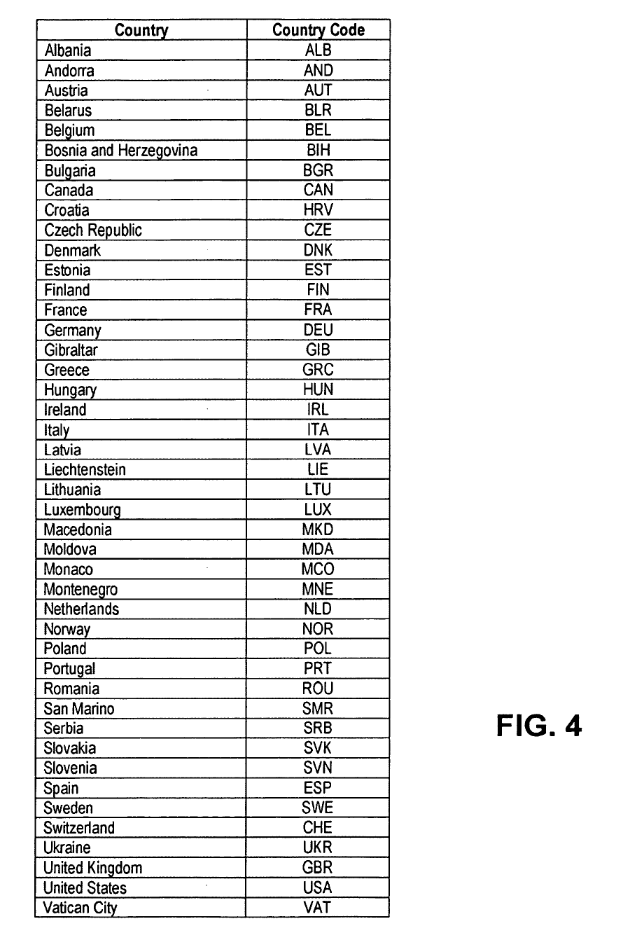

The flow begins in step 200. The “Welcome” page is displayed in step 205. FIG. 3 shows an example “Welcome” page of the Web application, according to embodiments. This page allows the user to select a language in which the current and subsequent pages will be displayed. For example, language selections English, French, Spanish, Dutch, Italian, and German are shown in FIG. 3 as links EN, FR, ES, NL, IT, and DE 310, from which the user can select. This page also enables the user to select an initial map location where the anomaly is located. The user specifies the initial map location by selecting a country name from a country drop down box 320. FIG. 4 shows an example table of country names and corresponding country codes used with the “Welcome” page of FIG. 3, according to embodiments. When a user selects the country drop down box 320, a localized list of the country names shown in table of FIG. 4 is displayed to the user in the drop down box, and the user selects a country name. A localized list means that the country names are translated to the local language selected by the user on the “Welcome” page. In embodiments, country is a required field. If the country selected is either United States or Canada, the user is required to select a state/province from a state/province drop down box 330. Once the user has selected the initial map location, he or she can click the Report Map Feedback virtual button 340 which takes the user to the “Where” page.

In step 210 of FIG. 2, the “Where” page is displayed to the user with a dynamic map image of the location chosen by the user in the “Welcome” page. The “Where” page, and all subsequent pages, are displayed in the language chosen by the user on the “Welcome” page. FIGS. 5A and 5B show example “Where” pages of the Web application, according to embodiments. FIG. 5A shows a map for a requested address in Boston, Mass., in the United States, and FIG. 5B shows a map for a requested latitude and longitude.

Alternatively, a partner can create their own “Welcome” page, branded to their application and hyperlinked directly to the “Where” page. In this case, the partners' “Welcome” page can pass form variables for both the language and initial map location to the “Where” page.

In FIGS. 5A and 5B, when the user is first shown the “Where” page, a default map image location is shown in dynamic map pane 510 for the country 320 and state/province 330 specified by the user on the “Welcome” page. If in step 215 the map image does not display the location of the anomaly, then in step 220, the user changes the map view by either entering address information into the find a place area 520 of the page, by entering latitude and longitude coordinates in the enter latitude and longitude area 525 of the page, or by using the map direction control bars 530 on the dynamic map pane 510 or map zoom control bars 535 to the right side of the dynamic map pane 510. The “Where” page contains a variety of controls to manipulate the geographic extent covered by the map, including the find a place area 520 and enter latitude and longitude area 525 of the page. The geographic extent covered by the map is the geographic area covered by the map at a particular scale or zoom level. In the system, the geographic extent is specified by two pair of latitude/longitude coordinates that define a rectangular area in space.

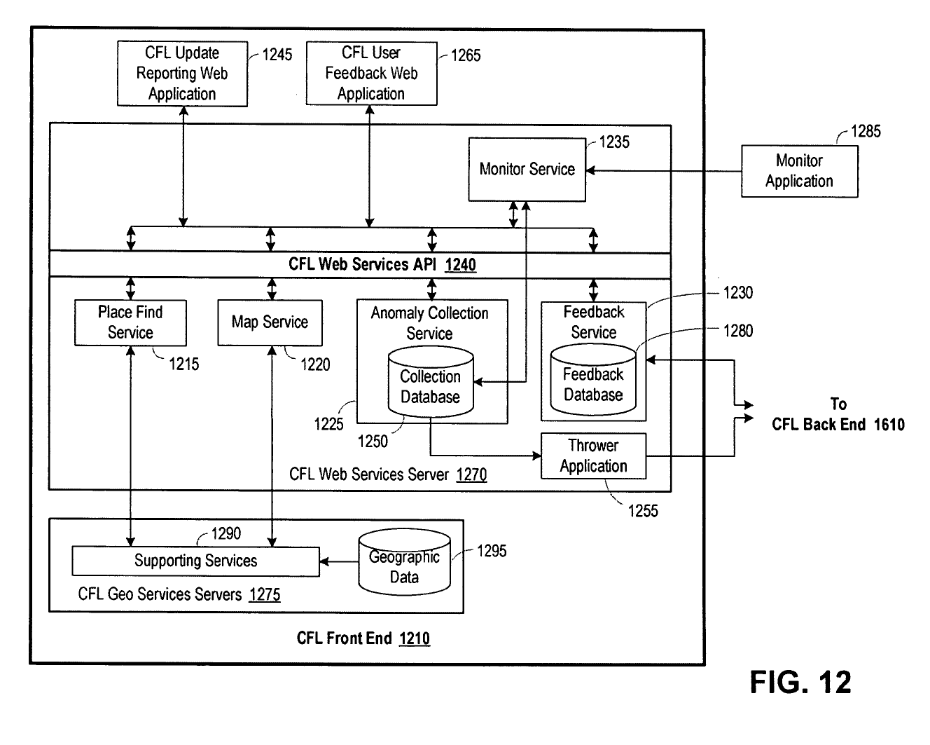

A place find service is used to locate geographic data for a place specified by the user in the find a place area 520 of the “Where” page. The place find service, which is a web service utilized by the CFL front end 105 of FIG. 1, is discussed below in more detail in the discussion related to FIG. 12. The place find service takes user entries as input. The user can enter information into a combination of screen fields including a house number field 540, street name field 545, city field 550, state/province field 555, and postcode or zip code field 560, as well as selecting from a country drop down box 565, to relocate the map image in the dynamic map pane 510 to a specific anomaly location. The country drop down box 565 is used as described above for the “Welcome” page of FIG. 3. Once the user is finished entering address information, the user clicks on the map place virtual button 570, resulting in a call to the place find service. The place find service returns a list of zero or more results which are displayed in the place find results area 575. The results are displayed in a list box with the first result selected.

The geographic extents of the selected result are included in a request to a map service, which renders the resulting map image in the dynamic map pane 510 on the “Where” page. The map service, which is a web service utilized by the CFL front end 105 of FIG. 1, is discussed below in more detail in the discussion related to FIG. 12. In the example of FIG. 5A, the user entered “Boston” in the city field 550 and “MA” (Massachusetts) in the state/province field 555. The user also used the country drop down box 565 to select “United States.” The user did not enter a house number, street name or a postcode in this example. After the user clicks on the map place virtual button 570, the resulting image of Boston, Mass., United States is rendered by the map service and displayed by the Web application to the dynamic map pane 510. In embodiments, the map service is capable of displaying multiple versions of proprietary geographic data.

In the enter latitude and longitude area 525 of the “Where” page, the user can also enter latitude and longitude coordinates in the latitude field 580 and the longitude field 585, respectively, to relocate the map image in dynamic map pane 510 to a specific anomaly location. After entering latitude and longitude, the user clicks on a map location virtual button 590, and the map service renders the resulting map image which is displayed in the dynamic map pane 510 by the Web application on the “Where” page. FIG. 5B shows an example “Where” page, in which the user entered a latitude of “41.073” in the latitude field 580 and a longitude of “−74.048” in the longitude field 585 of the enter latitude and longitude area 525 of the page. After the user clicks on the map location virtual button 590, the Web application displays for latitude and longitude coordinates centered in the dynamic map pane 510 on the “Where” page, the geographic location associated with the latitude and longitude coordinates, which in this example is a location in Chestnut Ridge, N.Y., in the United States.

The user can also use virtual buttons to directly manipulate the map image in dynamic map pane 510 in order to select the anomaly location. The user can click on map zoom control bars 535, shown to the right of the dynamic map pane 510. The zoom levels range from street to city to region up to country, as shown in FIGS. 5A and 5B. The lower zoom bars zoom out to the country level. The upper zoom bars zoom in to the street level. An indicator 536 in FIG. 5A shows that the map image in dynamic map pane 510 is displayed at a zoom level of region. The indicator 536 in FIG. 5B shows that the map image is displayed at a zoom level of city. The user can click on the map image to recenter it at the click point. The user can also use the map direction control bars 530, 531, 532, and 533 on the four sides of the map to pan to the north, south, east, or west, respectively. The user can click and drag on the map to produce a rectangle which will cause the map to be redrawn to best fit the geographic extents indicated by the rectangle. Preferably, the user will zoom in to the maximum scale that fully contains the anomaly. In embodiments, instructions are given to the end user on the “Where” page on how to use any of the dynamic map controls and other tools. The end user can use any and all tools on the “Where” page iteratively until the desired location is shown at the desired scale.

Some anomalies exist at a point, others exist as a line, such as along a street side or on a street segment, and still others exist as an area such as a water feature, or a county boundary feature. If the user wishes to describe a point feature instead of an area feature, the user clicks on the show crosshairs checkbox 592. If the user clicks the show crosshairs checkbox, cross hairs 593 that look like a “+” sign appear on the map image in dynamic map pane 510 to clearly identify the map center. If the cross hairs 593 are not already centered on the anomaly location, the user clicks the anomaly location on the map to identify the location. The user's perception is that he or she is now describing a point location. Regardless, for data storing purposes, map boundary coordinates, or map extents, as described above, are collected.

At any time while using the “Where” page, should the user find that the anomaly appears fixed, the user can click on the issue appears fixed checkbox 595 on the “Where” page. The purpose for this checkbox 595 is to provide validation of the geographic database. The user continues with the same reporting process as described in FIG. 2, but the data finally submitted to the application by the user indicates that the user is confirming that the geographic data for the “anomaly” location and type is actually correct, rather than that the user is requesting an update to the geographic data. An example of when user would need to use this checkbox 595 is if the user originally noticed the issue on a portable navigation system whose geographic data had not been updated for some time.

Returning to the flow chart of FIG. 2, once the user has created a map display illustrating the location of the anomaly in step 215, the user can click on the next virtual button in step 225 to continue to the “What” page. As the user moves to the “What” page, the application captures the geographic extent of the map in several form variables. A form variable is a generic term for a parameter that is passed between the user's 115 web browser and the server side CFL web application 130, as shown in FIG. 1.

The “What” page is displayed in step 230. FIGS. 6A and 6B show example “What” pages of the Web application, according to embodiments. The “What” page contains a static though smaller map image 610 that was previously displayed in the dynamic map pane 510 of the “Where” page. The “What” page shows a set of actions and objects used to specify anomaly types. The bold labels in the column to the right of the small map 610 provide a list of high level actions 615-645 a user can request of the map maker to address the issue, while the hyperlinks below each of those actions are the objects on which the action operates. An action of add 615 requests that certain geographic data be added to the proprietary geographic database, while remove 620 indicates certain geographic data should be removed. Rename 625 indicates that the name of certain geographic data elements in the proprietary geographic database be changed. Move 630 indicates that the map maker should relocate a certain geographic data element in the proprietary geographic database. Update traffic restrictions 635 indicates that the map maker should modify certain traffic related attributes in the proprietary geographic database. Fix routing rules 640 indicates that the map maker should modify certain routing related attributes in the proprietary geographic database. Finally, other 645 indicates other requests not covered by the above actions.

Organized subordinate to each of these actions are objects on which the action operates. Example objects for the action add 615 are street address 650, road or feature 651, highway entrance/exit 652, toll 653, and points of interest 654. These objects are implemented by rendering the objects as hyperlinks. Taken together, the action and object describe a request to the map maker such as “Add a Street Address.” By refining these actions and objects with further information, the user can describe a set of very specific anomaly types.

Describing anomaly types in terms of specific instructions for the map maker, for example “Add a Street Address,” makes the identification of anomaly types easier for the user.

By isolating the location of an anomaly in the “Where” page and anomaly type in the “What” page, the specific object or attribute that the user is reporting is identified, which has enormous benefits for automation.

Returning to FIG. 2, on the “What” page, the user determines an action for the map maker to take in step 235. In step 240, the user clicks on an object of this action. When the object hyperlinks are clicked on the “What” page, a set of description fields are displayed on the page in step 245 in a description fields area 670, labeled by the action 660 and object 661 selected by the user. For example, in FIG. 6A, the user selected action update traffic restrictions 635, shown in action 660, and object turn restriction 656, shown in object 661. The description fields area 670 allows the user to select and/or input additional information. In step 250, if the user has not found the type of problem he or she wants to describe, the flow loops back to step 235, and the user determines another combination of action and object. If the user found the type of problem the user wants to describe in step 250, the user fills out the anomaly description fields on the “What” page in step 255.

For example, as shown in FIG. 6A, for an action update traffic restrictions 635, if the user clicks on the object turn restriction 656, the description fields area 670 specific to the action and object combination is displayed to the user. An anomaly type field 671 is an example of one of the description fields. The user clicks on the associated type drop down box to view a finite set of anomaly types for the action and object combination.

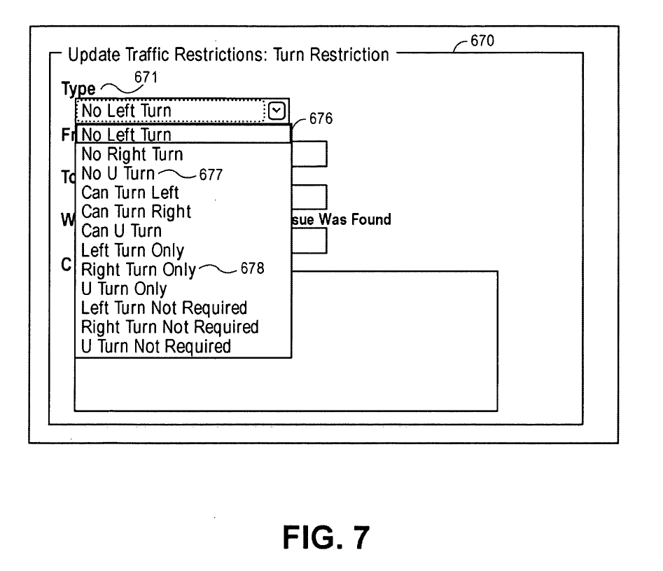

FIG. 7 shows an example set of anomaly types for the example “What” page of FIG. 6A, according to embodiments. For the action update traffic restrictions 635 and the object turn restriction 656, the user would then select the type that fits the anomaly the user is trying to describe, for example, no U turn 677 or right turn only 678, as shown in the type drop down box 671 of the description fields area 670 in FIG. 7. In this example, the resulting anomaly type selected by the user is no left turn 676 in FIG. 7, as is also shown in the type drop down box 671 of FIG. 6A.

Other examples of description fields in FIG. 6A are from street name field 672 and to street name field 673. Another example is the website or device where issue was found field 674 in which the user can describe the application or device where they discovered the anomaly. Another example is the comments field 675, in which the user can enter supplemental information to further describe the anomaly, as users may want to add additional information. This is done in an effort to keep the user from polluting the structured data fields such as from street name field 672, to street name field 673 or website or device where issue was found field 674. Automated processes will not use the data the user entered into the comment field 675, as this data is unstructured, language-dependent data that cannot be interpreted by an automatic process. However, this field can be useful for manual auditing of the system.

FIG. 6B shows another example of the “What” page, according to embodiments. The user selected action add 615 and object points of interest 654. In the description fields area 670, labeled by the action 660 and object 661 selected by the user, another example of a description field called POI name 680 is displayed to the user and in which the user can input the name of the point of interest that is missing on the map. Other example description fields are website or device where issue was found field 674, and comments field 675, which are the same as those described for FIG. 6A. Note that no type drop down box 671 is necessary on the FIG. 6B “What” page, however, because the system determines the anomaly type is “MissingPOI,” as discussed in more detail below.

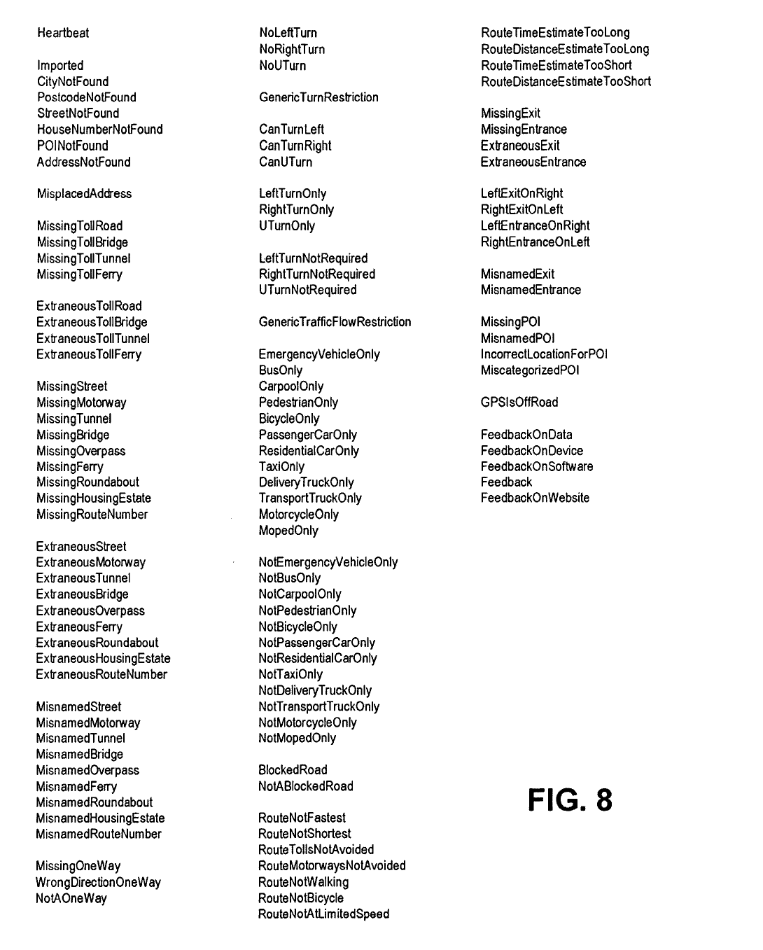

FIG. 8 shows a further example set of anomaly types for the actions and objects on the “What” pages of FIGS. 6A and 6B, according to embodiments. FIG. 8 is not intended to be a complete set of anomaly types, however. These anomaly types are selected by the user who chooses an action such as add 615, and an object such as road or feature 651, on which the action operates. Additionally, the user optionally selects or enters some supplemental details about the selected action and object combination.

Some combinations of actions and objects completely describe an anomaly type, for example in FIG. 6B, an action add 615 and object points of interest 654, the anomaly type is “MissingPOI,” which is determined by the system and can be found in the set of anomaly types in FIG. 8. In this case, no additional anomaly type information is needed from the user. For example, the type pull down box 671 on the “What” page is thus not displayed to the user. In another example for an action move 630 and an object street address 655, the system determines the anomaly type is “MisplacedAddress,” as shown in FIG. 8.

Some action and object combinations do not completely describe an anomaly type, for example, the FIG. 6A example. For an action update traffic restrictions 635 and object turn restriction 656, there are a number of anomaly types in FIG. 8 describing various types of traffic restrictions that could be added to the proprietary geographic database. Thus, for this example, the type field 671 is necessary on the “What” page so that the user can select one of the anomaly types from the associated drop down box. In this case, the action and object are combined with an entry selected by the user in the type field 671 to form an anomaly type in FIG. 8. For example, the resulting anomaly type could be “UTurnNotRequired.”

If for any reason, and at any point while using the “What” page, the user feels that he or she has not properly described the location of the anomaly, the user can click the previous virtual button 690 to return to the “Where” page to further refine the location of the anomaly.

Returning to FIG. 2, once the end user has completed the anomaly description fields area 670, the anomaly type is fully described. At this point, in step 260, the user can click the “Next” button which causes the “Verify” page to be displayed in step 265.

Thus, the user can describe the type of a problem and the location of a problem in a manner that an automated process can recognize, although the system can also use some manual processes to resolve these problems. The type of the end user geographic data update request is described using enumerated values, implemented as a set of string constants, such as “MissingAddress” or “MisnamedStreet,” as well as structured data description fields, for example, a correct name field in which the user enters the correct name of a misnamed street. The location of the problem is expressed by a geographic extent, specified by two pair of latitude/longitude coordinates that define a rectangular area in space. The enumerated values, structured data fields and geographic extents are language neutral and thereby avoid any dependency on translation.

Thus, the enumerated values, structured data fields, and geographic extents enable automated processing of updates to the geographic data. Use of the language “automatically processing” and “to enable the automated processing of updates to the geographic data” does not limit the processing to automated processes. One or more manual processes can still be used in addition to the automated processes. All of these processes combined together handle processing of anomalies, as well as other related processing, and ultimately handle processing of updates to the geographic data.

FIG. 9 shows an example “Verify” page of the Web application, according to embodiments. The “Verify” page displays the same static smaller map image 610 as on the “What” page of FIG. 6A, as well as summarizing the action 660, object 661, and further descriptive elements 670 the user selected on the “What” page of FIG. 6A. The “Verify” page further invites the user to enter his or her email address in an email address field 910 in order that the map maker can notify the user of changes in status of the user's anomaly submission.

The user reviews the data displayed on the “Verify” page in step 270. In step 275, if the user is not satisfied with the data he or she entered, the user can click the previous virtual button 920 and return to the “What” page in step 230 to add, modify, or remove information on the page. If instead the user is satisfied that the data displayed describes the anomaly he or she wishes to report, the user can click the submit virtual button 930 in step 277.

In step 280, the anomaly data, including the anomaly location specified by the user on the “Where” page and type specified by the user on the “What” page is transferred to an anomaly collection service 1225, which stores the anomaly in a collection database 1250 and returns a unique tracking number. Details of this transferring and storing can be found in the discussion related to FIG. 12 below.

The “Acknowledgment” page is displayed to the user in step 285 with a message that the map discrepancy entered by the user has been submitted to the system. FIG. 10 shows an example “Acknowledgment” page of the Web application, according to embodiments. The “Acknowledgment” page displays the unique tracking number 1010 supplied by the anomaly collection service 1225 when the anomaly was collected. It also provides a hyperlink 1020 to allow the user to report of additional feedback. If the user clicks the hyperlink 1020 to provide additional feedback in step 290, the flow loops back to the “Where” page of the flowchart in step 210, and the user enters another map discrepancy. If the user does not click the hyperlink 1020 to provide additional feedback in step 290, the process ends in step 295.

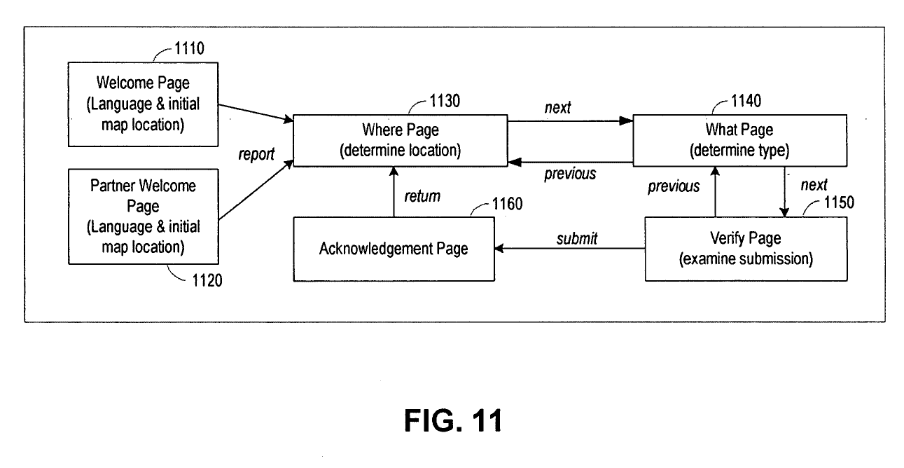

FIG. 11 illustrates an example high level view of the page flow described in the Web application flowchart of FIG. 2, according to embodiments. Using either the welcome page 1110 or alternatively a partner branded version of the welcome page, or partner welcome page 1120, the language and initial map location information entered by the user on this page are passed to the where page 1130. The user determines the location of the anomaly using the where page 1130 and clicks next to go to the what page 1140. On the what page, the user determines the type of the anomaly and then clicks next to go to the verify page 1150. On the verify page 1150, the user verifies the information in his or her submission and clicks submit to submit the anomaly. At this point, the user sees the acknowledgment page 1160, and clicks the hyperlink to provide additional feedback in order to go back to the where page 1130 to enter additional anomalies. On both the what page 1140 and verify page 1150, the user has the choice of returning to the previous page to refine the location on the where page 1130 or type of the anomaly on the what page 1140, respectively.

### CFL Front End

FIG. 12 illustrates an example front end of the customer feedback loop (CFL), according to embodiments. The CFL front end 1210 includes a number of web services, all accessed through a CFL Web services API 1240 via simple HTTP get and post requests. The web services include a place find service 1215 for locating places, a map service 1220 for rendering map images, an anomaly collection service 1225 for collecting submitted anomalies, a feedback service 1230 for supplying anomaly data and status, as well as processing user feedback, and a monitor service 1235 to monitor proper operation of the system. The CFL front end 1210 shows additional details for the CFL front end 105 in FIG. 1. The place find service 1215 and map service 1220 are optional services, while the system requires use of the anomaly collection service 1225 and feedback service 1230. The monitor service 1235 is an operational support service and is not part of the CFL Web services API 1240. The monitor service is thus not intended for partners to use.

The place find and map services 1215, 1220 utilize a set of supporting geographic services shown as supporting services 1290 on the CFL geo services servers 1275. The supporting services 1290 have access to geographic data 1295. The separation of the place find and map services' 1215, 1220 web service functionality from the supporting functionality is designed to allow flexibility in the choice of supporting services 1290 for the place find and map services 1215, 1220.

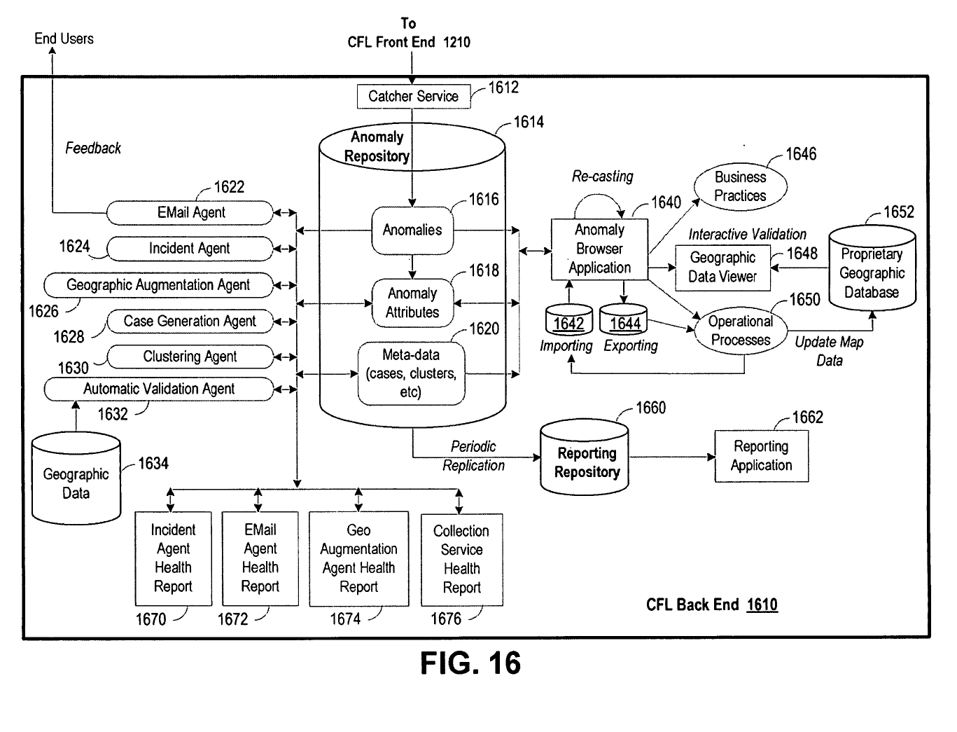

A CFL update reporting Web application 1245 allows end users to describe anomalies and report them. Partners can choose to implement a similar web application utilizing the place find service 1215 and map service 1220 or can use their own place find and map services along with anomaly collection service 1225. For example, a partner hosting a consumer facing maps and driving directions service could present their own proprietary maps and find place capabilities to the end user and still submit the perceived error to the anomaly collection service 1225. Upon collection, the anomalies are stored in the collection database 1250 until such time as the thrower application 1255 reads them out and transfers them to the CFL back end 1610, details of which are discussed in relation to FIG. 16.

A CFL user feedback Web application 1265 allows end users to view the status of anomalies they have reported to the system as well as to indicate whether or not the problem has been corrected. This CFL user feedback Web application 1265 utilizes the feedback service 1230 both to access the current statuses of reported anomalies via the feedback database 1280, as well as to provide users' comments on those statuses. Partners can choose to implement a similar web application utilizing the feedback service 1230.

The place find service 1215, the map service 1220, the anomaly collection service 1225, the feedback service 1230, and the monitor service 1235 are bundled together on a single computer referred to as the CFL Web services server 1270. Multiple CFL web services servers 1270 can exist in the system. Each of these servers uses one or more servers shown as CFL geo services servers 1275 for the core place find and map rendering functionality.

The thrower application 1255 runs continuously and periodically awakens to check the collection database 1250 for anomalies that have not yet been transferred to the CFL back end 1610. When thrower application 1255 finds such anomalies, it reads them out and transfers them over a network, typically the Internet, via an HTTP post command to a web service called the catcher service 1612 located in the CFL back end 1610 as shown in FIG. 16.

The monitor application 1285 is an external application and is not strictly part of the CFL front end 1210. The monitor application 1285 periodically issues requests to the monitor service 1235 to verify proper system operation.

There are multiple CFL Front Ends transferring anomalies to a single CFL Back End. Additional CFL Front Ends can be added to accommodate rising usage by end users.

### CFL Web Services Application Programming Interface

As shown in the CFL front end 1210 in FIG. 12, the CFL Web services API 1240 provides access to several web services via simple HTTP get and post requests. The services include the place find service 1215 for geocoding, the map service 1220 for rendering maps, the anomaly collection service 1225 for collecting anomalies, and the feedback service 1230 for gathering end user feedback on anomaly status. Each of these services requires the specification of a client identification variable, or ClientId. The ClientId is a string defined by the system and refers to a business partner. The system can check for a valid ClientId. By tracking the ClientId of each request, the system can determine the usage patterns of various clients.

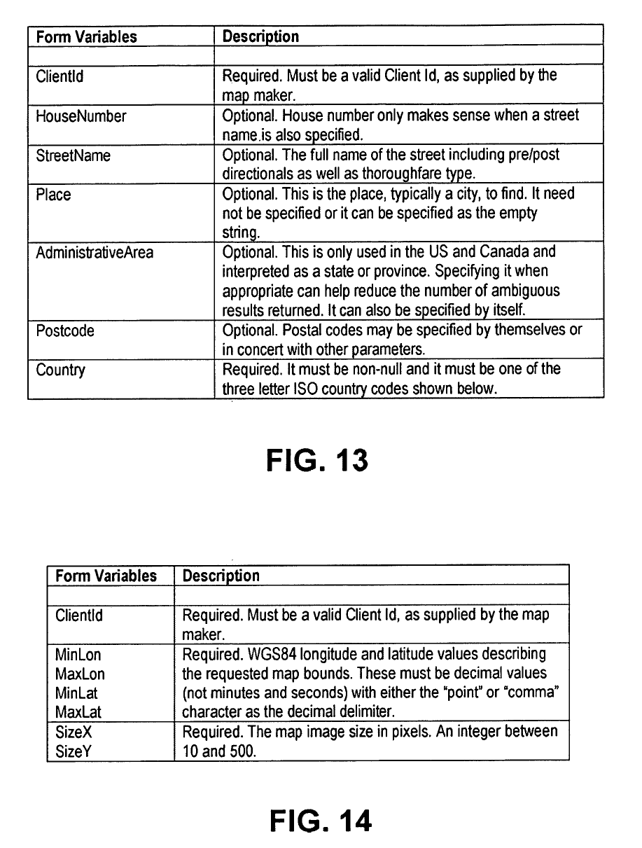

FIG. 13 shows an example table of map place form variables used with the place find service of the CFL front end, according to embodiments. The place find service 1215 is accessed by performing an HTTP post command to a URL of the form “http://{cflservice}/PlaceFind,” including some combination of the variables described in FIG. 13. As with the other services, ClientId is a required parameter and must have a valid value, as supplied by the system. HouseNumber, StreetName, Place, AdministrativeArea, Postcode, and Country variables contain the elements of the address the client wishes to find. HouseNumber and StreetName are optional and must include a house number to return a specific point address. Place is optional and is generally a city or other type of locality. AdministrativeArea is optional and is used to mean different things in different countries. It is interpreted as a state or province in the United States or Canada. Specifying it when appropriate can help reduce the number of ambiguous results returned to the user. Postcode or ZIP Code is optional. In embodiments, Country is required. It must be non-null and it must be recognized as one of the three letter ISO country codes as shown in FIG. 4. These ISO country codes are standard country codes first published by the International Organization for Standardization (ISO) and are specification “3166-1 Alpha-3” country codes.

The place find service 1215 attempts to return the most precise location description possible given the variables supplied. For example, if no street was specified then the most precise location description may be a city or postal code. If the place find service 1215 is successful in determining a location, it returns a text response string containing the name of the location found, as well as the location's geographic extents. If multiple results are found, the name and location of each result is specified along with a geographic extent covering all of the results. The place find service 1215 relies on core supporting lookup services which utilizes the latest version of the map maker's proprietary geographic database. As the map maker improves the quality and completeness of their geographic data, this database is updated to provide the most current experience possible for the end user.

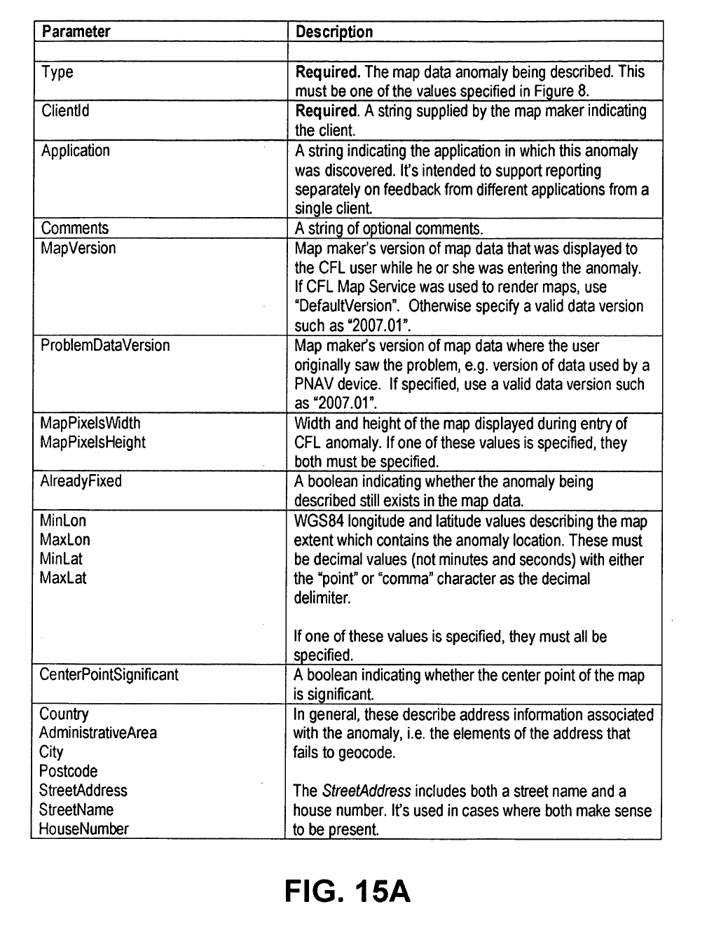

FIG. 14 shows an example table of map location form variables used with the map service of the CFL front end, according to embodiments. The map service 1220 is accessed by performing an HTTP get request to a URL of the form “http://{cflservice}/Map,” which includes the variables described in FIG. 14. As with the other services, ClientId is a required parameter, and must have a valid value, as supplied by the system. MinLon, MaxLon, MinLat, and MaxLat are determined by the system and specify minimum and maximum longitude and latitude. These four variables constitute the boundaries or extent of the requested map. These variables are required and are WGS84 longitude and latitude values describing the requested map bounds. WGS84 stands for World Geodetic System, 1984, and is datum which defines the frame of reference for geographic data. These WGS84 values must be decimal values and not in minutes and seconds. The decimal delimiter is either the point or comma character. SizeX and SizeY are required numbers determined by the system which describe the map image size in pixels. These numbers are integers in the range between 10 and 500.

If successful in determining a correct map image to display to the user, the map service 1220 will stream the resultant Portable Network Graphics (png) file back to the client, which displays the map image. If any parameters are not valid, the map service 1220 returns an HTTP 400 error. The map extents must be specified by valid latitude and longitude values. An example Uniform Resource Locator (URL), or web address, that returns the map of North America is “http ://MapMaker'sWebsite.com/Map?ClientId=AClientID&MinLat=40&MinLon=75&MaxLat=41&MaxLon=−74&SizeX=500&SizeY=450.”

The map service 1220 relies on core supporting map rendering services which utilizes the latest version of the map maker's proprietary geographic database. As the map maker improves the quality and completeness of its data, this database is updated to provide the most current experience possible for the end user.

The feedback service 1230 is accessed by performing an HTTP get request with the anomaly tracking number as the parameter. The feedback service 1230 looks up that global unique identifier in a feedback database 1280 and returns information about the anomaly, including the anomaly's current status. The feedback service 1230 enables an end user web application, such as the CFL user feedback Web application 1265, to display all relevant information about an anomaly for an end user to evaluate.

The feedback service 1230 can also be accessed by performing an HTTP post command with an anomaly tracking number and a description of the end user's evaluation of the anomaly's current status. The feedback service 1230 enables an end user application, such as the CFL user feedback Web application 1265, to provide feedback on anomalies that they have reported.

The anomaly collection service 1225 is accessed by performing an HTTP post command to a URL of the form “http://{cflservice}/Collection,” which includes variables describing the type, location, and other details about the anomaly. The service performs minimal validation of the posted variables and inserts this data into a collection database 1250. The anomaly is provided in the form of case sensitive form variables. Each anomaly must contain an anomaly type form variable that describes the type of the anomaly, for example “MissingStreet.” Failure to include this variable will result in an error being returned from the HTTP post, and the collection database 1250 will not be updated. As with the other services, ClientId is also a required parameter, and must have a valid value, as supplied by the system. For each anomaly type, there is a set of parameters appropriate to that type. For example, the MissingStreet anomaly should include such parameters as the name of the missing street. Strictly speaking, all the anomaly's parameters, excluding the anomaly type and ClientId, are optional. Thus, the HTTP post command can fail to specify the name of the missing street, but will still succeed, and the data will be inserted into the collection database 1250. The record inserted, however, is not as useful as it could be, given that it does not describe which street is missing.

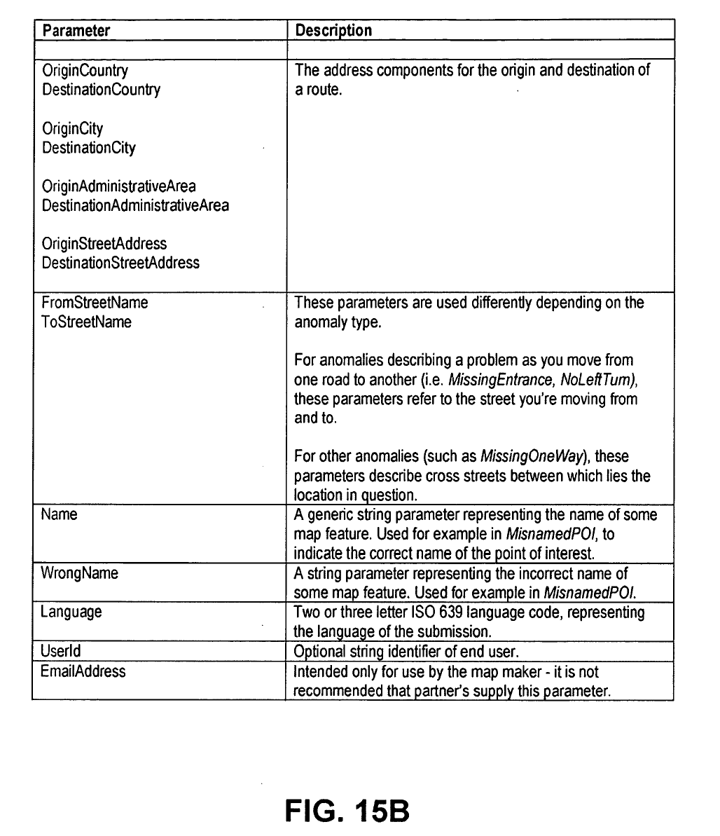

FIGS. 15A and 15B show an example list of anomaly parameters accepted by the anomaly collection service 1225 of the CFL front end 1210, according to embodiments. FIGS. 15A and 15B also include descriptions of parameter definitions and notes on how they are used in the system.

In FIG. 15A, a Type parameter is required for all anomalies. It is the geographic data anomaly being described and must be one of the values specified in FIG. 8. A ClientId parameter is required for all anomalies and must have a valid value. It is a string supplied by the map maker indicating the client. An Application parameter is an optional free form string describing the application in which the issue was discovered. A Comments parameter is a string of optional comments and is accepted for all anomalies. A MapVersion parameter is also optional and describes the version of the geographic data the user was viewing when he or she reported the issue. A ProblemDataVersion parameter is optional, but if supplied, should be one of the valid values defined by the system. ProblemDataVersion is the version of the data in which an anomaly was discovered, or the version for which the user is reporting the anomaly. For example, if the user is using the 2005.2 release of proprietary geographic data, “2005.2” would be specified. A list of valid values is provided to the developers using the API.

MapPixelsWidth and MapPixelsHeight are the width and height, respectively, of the map displayed during user entry of the CFL anomaly. If one of these values is specified, they must both be specified. An AlreadyFixed parameter indicates whether the currently viewable map shows that the anomaly has been fixed in the geographic data. If the parameter is present, its value must be either true or false, as set by the user when he or she clicks on the issue appears fixed virtual checkbox 595 on the “Where” page, as shown in FIGS. 5A and 5B. Not all anomaly types include this parameter, as not all anomalies can be verified through viewing the map, such as routing anomalies, for example.

MinLon, MaxLon, MinLat, and MaxLat parameters describe the map extent which contains the anomaly location. If one of the map extent values is specified, then all the values must be specified. If map extent parameters are specified, a CenterPointSignficant parameter can be specified to indicate whether the center point of the map is significant. For example, the user can have selected a checkbox that drew a crosshair at the center of the map, to indicate the exact location of the problem. If present, its value must be true or false.

Address information parameters associated with the anomaly include Country, AdministrativeArea, City, Postcode, StreetAddress, StreetName, and HouseNumber, where StreetAddress includes both a street name and a house number.

FIG. 15B includes parameters OriginCountry, DestinationCountry, OriginCity, DestinationCity, OriginAdministrativeArea, DestinationAdministrativeArea, OriginStreetAddress, and DestinationStreetAddress. Routing anomalies utilize these origin and destination address contexts to describe the start and end point of a route. It is preferred that the value of OriginCountry and DestinationCountry, if specified, be one of the three letter ISO codes as required for place find in FIG. 4.

FromStreetName and ToStreetName parameters are used differently depending on the anomaly type. For example, these two parameters can describe a problem as one moves from one road to another, or these parameters can describe cross streets between which lies the location in question. The Name parameter represents the name of some map feature, WrongName represents the incorrect name of some map feature, Language is a two or three letter ISO 639 language code, representing the language of the submission. The UserId parameter is an option string to identify the end user, and EmailAddress is intended for use by the map maker and is not recommended that partners supply this parameter. All string parameters must be fewer than 256 characters except for Comments, which can be 1024 characters.

Successful post operations to the anomaly collection service 1225 return a string containing a success flag (a zero “0”) and a global unique identifier (guid), which can serve as a tracking number for the post operation: “0:{guid}.” Internal server errors return an error flag (“1”) indicating a temporary technical problem. Errant post operations return an error flag (“−1”), indicating a problem with the HTTP post command, followed by a colon-delimited series of error descriptions: “−1: {error description 1}: (error description 2}.”

If the post does not contain an anomaly type or contains an unrecognized anomaly type, the error description includes a list of all supported anomaly types. If the post includes an anomaly type but no parameters or an unrecognized parameter, the error description includes a list of all allowable parameters for that type.

There is a fundamental tension between specifying the geographic data problem in application specific terms, which is probably most intuitive for the user and specifying the geographic data problem in terms of the actual geographic data, which is probably most useful for the map maker. In attempting to balance these goals, the anomaly collection service 1225 defines multiple anomaly types described in application specific terms, which can describe the same underlying geographic data problem. The different anomaly types, however, can describe the problem with varying degrees of specificity. A prime example of this is the two anomalies “StreetNotFound” and “MissingStreet.” The “StreetNotFound” anomaly describes an application issue where a given street cannot be found in the list of streets in a given city, while “MissingStreet” describes the case where the user cannot find a known street in the map. Obviously, if the street is not in the underlying geographic data, it will not be displayed on a map or listed in the street list. In this case, receiving the “MissingStreet” anomaly is preferable because it makes a stronger statement about the problem. Anything that the CFL update reporting Web application 1245 can do to guide the user to submit more precise anomalies will result in more actionable data being collected.

The anomaly collection service 1225 supports the collection of structured anomaly data that can be processed by computer automation. This is achieved because the two critical elements of the anomaly, the location and type, are described in a machine readable format. The location is specified by a describing the two corners of the map extent with floating point numbers representing latitude/longitude values. The type is specified with an enumerated set of string constants. In this manner, the system is able to process very high volumes of data through automated means.

The anomaly collection service 1225 is language neutral. The service supports describing valuable information regardless of the end user's language. For most geographic data problems, the critical information is the location of the problem and the type of the problem. The API avoids a dependency on language translation by representing the location information as a map extent, or a pair of latitude/longitude pairs, meaning four sets of latitude/longitude coordinates, and the problem type as an enumerated set of string constants. Thus, the user facing CFL update reporting Web application 1245 is the only part of the customer feedback loop system that must be translated for the user in his or her language.

Web Services 1215, 1220, 1225, and 1230 support the CFL update reporting Web application 1245 and ultimately store anomaly information in the CFL back end 1610 as shown in FIG. 16.

Some partners will want full control of the reporting application, in which their customers describe the type and location of the problem. For that reason, the CFL Web services API 1240 is included in the system to provide the core services one might need to create such an application, including map rendering, place finding, and of course, anomaly collection. The API 1240 is presented with this granularity to support partners who wish to provide their own map rendering or geocoding or who get the location and type from other means. These partners would only utilize the anomaly collection service.

### CFL Monitor Service

Independent of the CFL Web services API 1240, there is an additional service, known as the monitor service 1235 that verifies the expected operation of the web services. The monitor service 1235 is periodically called by a monitor application 1285 on the local network of the CFL Web services server 1270. This periodic call to the monitor service 1235 results in calls to the place find service 1215, the map service 1220, and the anomaly collection service 1225 to ensure their expected operation. Additionally, the monitor service 1235 directly monitors the collection database 1250 to ensure the expected operation of the thrower application 1255. Specifically, it verifies that all anomalies are thrown to the CFL back end 1610 in accordance with the sleep period of the thrower application 1255. Any failures detected result in a notification to the caller, typically an external monitoring application.

When the monitor service 1235 posts data to the anomaly collection service 1225, it uses a special anomaly type referred to as a Heartbeat type. This Heartbeat anomaly type is also shown in FIG. 8. This anomaly type is ignored by most operational processes but, like all anomalies, it passes through the system through the thrower application 1255 to an anomaly repository 1614 in the CFL back end 1610 in FIG. 16 where it can ultimately provide a heartbeat to the collection service health report web application 1676. When the monitor service 1235 posts this heartbeat anomaly to the anomaly collection service 1225, the anomaly collection service adds the name of the CFL Web services server 1270 to the anomaly. As these anomalies pass through the system and end up in the anomaly repository 1614, they are examined by the collection service health report web application 1676. This web application continually examines the anomaly repository 1614 verifying the regular receipt, for example after some number of minutes, of these heartbeats from all the CFL Web services servers 1270 in the system. The collection service health report web application 1676 indicates not only the proper operation of the individual CFL Web services servers 1270, but also the proper operation of the entire loosely-coupled system comprised of multiple CFL front ends 1210 and the single CFL back end 1610. Normal operational processing ignores these heartbeat anomalies in the anomaly repository 1614.

### Processing of Anomalies: The CFL Back End

FIG. 16 illustrates an example back end of the customer feedback loop (CFL) according to embodiments. An anomaly is followed through the CFL back end 1610. While this is only an example, it touches on most of the elements of the CFL back end. The CFL back end 1610 shows additional details for the CFL back end 110 in FIG. 1.

When an example anomaly is posted to the catcher service 1612, it is immediately stored in an anomaly repository 1614. The anomaly data is stored in a read-only table anomalies 1616 in the anomaly repository 1614. The creation of the anomaly data triggers the automatic creation of a set of attributes associated with that anomaly. These anomaly attributes 1618 are stored in a separate database table in the anomaly repository 1614. These attributes include an anomaly status which is set to an initial state of “Start.”

Various autonomous agents run continuously on the anomaly repository 1614. An email agent 1622 is continuously looking for new anomalies and examining them to determine if they include the end user's email address. If so, the email agent will send the end user notification that the map maker has received the user's example reported anomaly and will update this example anomaly's corresponding anomaly attributes 1618 to indicate that this email has been completed.

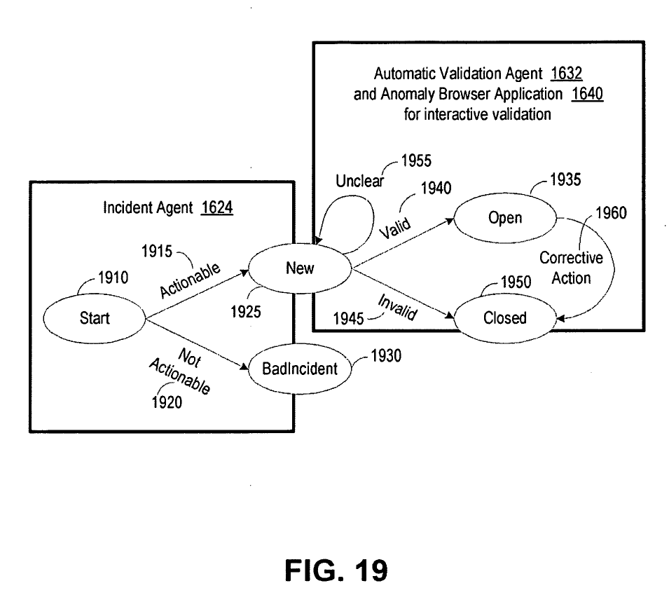

An incident agent 1624 examines new anomalies. If the incident agent finds the example reported anomaly to lack critical information, meaning the anomaly is not actionable, the incident agent will update the anomaly's status to “BadIncident.” More detail about anomaly statuses can be found in the discussion related to FIG. 19 below. If the anomaly is actionable, however, the incident agent will update the anomaly's status to “New,” and the anomaly will be a candidate for validation.

A geographic augmentation agent 1626 is continuously running and looking for new anomalies. When it finds the new example anomaly, it performs a geographic look-up procedure on the center point of the anomaly's map bounds. This look-up procedure uses a series of polygons describing various political and administrative regions such as country, state, and county. This procedure produces the name of the given extent, and the agent updates the anomaly's corresponding anomaly attributes 1618 to add the given extent name.

A case generation agent 1628 and a clustering agent 1630 are continuously running against the anomaly repository 1614 looking for new anomalies. When these agents find the new example anomaly, they will examine it to determine if it is either a duplicate of an existing anomaly, in which case both anomalies are said to belong to the same case, or is in close geographic proximity to other related anomalies, in which case these anomalies belong to the same cluster. Both cases and clusters are held as meta-data 1620 in the anomaly repository 1614. As an example, assume that the example anomaly belongs to a very high priority cluster which has already initiated an operational process 1650 designed to correct the anomalies in the proprietary geographic database 1652 that make up that cluster.

An automatic validation agent 1632 is continuously running against the anomaly repository 1614 looking for new anomalies. As an example, assume as it examines the example anomaly that it finds the anomaly to be a real issue in the latest geographic data 1634 supporting automatic validation. It then updates the anomaly's status to “Open.”

At any time, the map maker can use an anomaly browser application 1640 to view the details of the example anomaly, compare those details to the proprietary geographic database 1652, and independently verify that the anomaly describes a real problem in the database.

The proprietary geographic database 1652 is the map maker's reference database. Geographic data 1634 in the CFL back end 1610 and geographic data 1295 in the CFL front end 1210 are both derived from the proprietary geographic database 1652, as is the user's geographic data (not shown in figures) the user is using in his or her product. In general, the geographic data 1634 is updated more frequently than the geographic data 1295, which in turn may be updated more frequently than the geographic data the user is using in his or her product. In embodiments, the proprietary geographic database 1652 is used to derive an updated version for the geographic data 1634 and/or 1295, as well as to release data that becomes available in products for the user.

For the example anomaly, if the operational process 1650 initiated by the high priority cluster to which the new example anomaly belongs completes, a large set of updates is committed to the proprietary geographic database 1652. Some time later, this reference database is replicated to the geographic data 1634 supporting the automatic validation agent 1632. The next time the automatic validation agent 1632 runs against the example anomaly, it determines that the problem has been corrected because updates were made to geographic data 1634 to correct the anomaly. At this point, the agent 1632 updates the anomaly's status to “Closed” and notes the production version of the database in which the fix is included. The anomaly status and database version are updated for the anomaly in the anomaly attributes 1618.

At some later time, this new version of the data including the fix for the example anomaly is loaded into the CFL front end 1210 geographic data 1295 in the CFL geo services servers 1275 in FIG. 12. At this point, the email agent 1622 is triggered to send email to those users who included their email address with their anomaly submissions suggesting that the user use the CFL user feedback Web application 1265 to examine the anomaly and provide feedback on whether or not the issue has been correctly addressed.

The end user can examine the anomaly status on the CFL user feedback Web application 1265, which utilizes the feedback service 1230 to display the anomaly's data and latest status, and can confirm or deny that the anomaly has been correctly addressed. The feedback service 1230 sends a message to the CFL back end 1610 indicating that the end user has confirmed or denied that the anomaly has been properly addressed, and the anomaly attributes 1618 associated with the anomaly are updated accordingly with this user feedback.

### CFL Back End Details

The catcher service 1612 is a web service accessed by performing an HTTP post command containing all the data describing a user reported anomaly. The catcher service 1612 receives the posted data from the thrower application 1255 on a number of CFL front end servers 1270, and stores this data in the anomaly repository 1614 to be further processed by the CFL back end 1610.

The anomaly repository 1614 itself is a database containing both the raw anomalies 1616 as well as data about the anomalies, referred to as anomaly attributes 1618. Once the anomalies have been written to the repository, they can only be read, but the associated anomaly attributes can be read or written. These attributes include, but are not limited to, flags indicating which emails have been sent to the end user, address information such as the county, state, or country containing the center point of the anomaly's map bounds, and an anomaly status value. Status values include, but are not limited to, “Start” which indicates that the anomaly has just arrived in the repository, “BadIncident,” which indicates that the anomaly is not actionable, “Open” which indicates that the anomaly indicates a real problem with the map maker's proprietary geographic database, and “Closed” which indicates that the anomaly does not now, or perhaps never did, indicate a real problem with the map maker's proprietary geographic database. In embodiments, other status values are used to facilitate the anomaly's use by various proprietary operational processes.

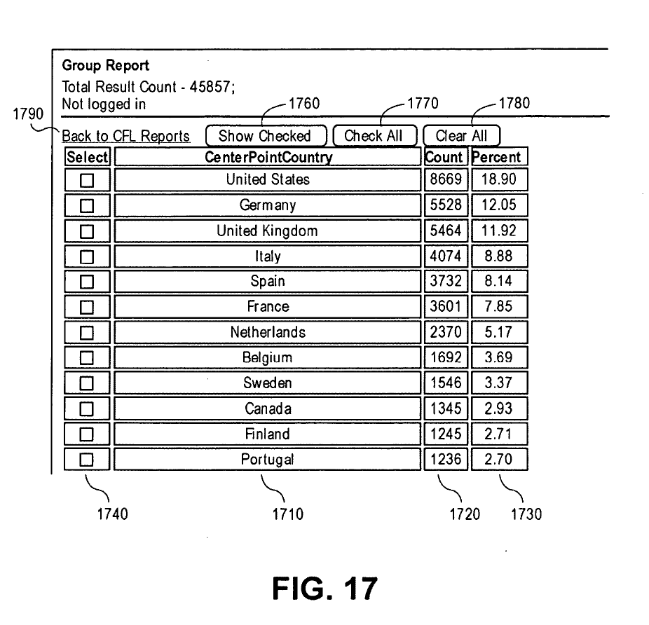

Various applications operate on the repository including the anomaly browser application 1640. The anomaly browser application allows the map maker to review the anomalies in the anomaly repository 1614 both in aggregate and individually. FIG. 17 shows an example anomaly group report provided by the anomaly browser application 1640 of the CFL back end, according to embodiments. The anomaly browser application 1640 allows partitioning the anomalies into groups, for example, by the country anomaly attribute under the CenterPointCountry column 1710, as shown in the group report of FIG. 17. Grouping is also allowed according to other anomaly attributes (not shown). FIG. 17 also shows for each country the number of anomalies under the count column 1720. The percentage for each country of the total number of anomalies is shown in the percent column 1730. The map maker can choose to see additional information about anomalies for a country by selecting the associated check box in the select column 1740. To further assist the map maker in selecting countries, the map maker can select the show checked virtual button 1760 to show only the countries selected, the check all virtual button 1770 to select all countries, and the clear all virtual button 1780 to deselect all countries. The user may also click on the back to CFL reports hyperlink 1790 to view other reports discussed below.

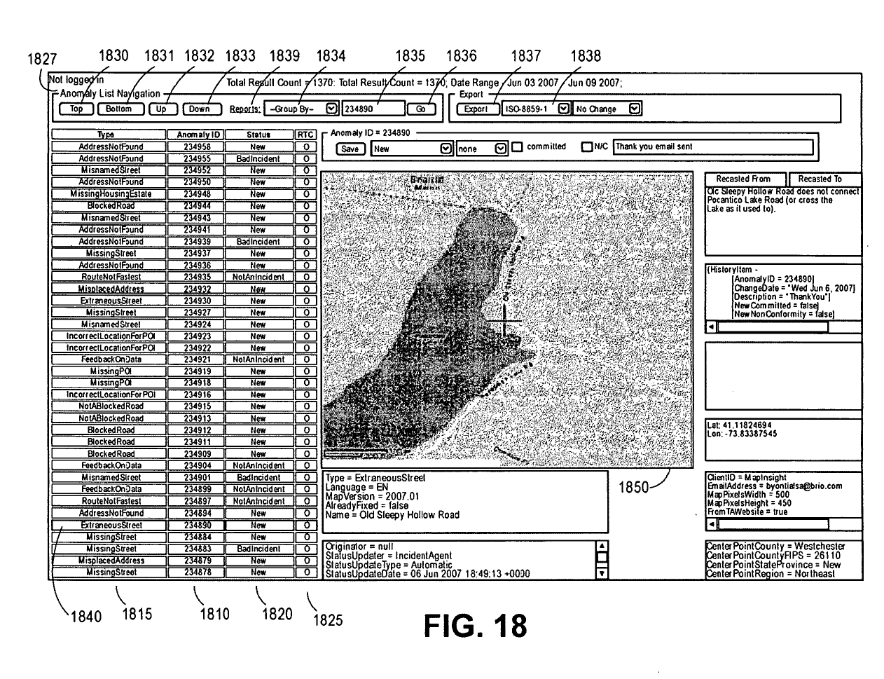

FIG. 18 shows an example screen of the anomaly browser application 1640 of the CFL back end, according to embodiments. The anomaly browser application 1640 supports examining individual anomalies and their associated attributes in detail. This screen will be displayed to the map maker when the map maker selects a group of anomalies to view in a group report, such as the anomalies of a country in FIG. 17. In FIG. 18, for the anomaly currently highlighted 1840, anomaly attributes are shown such as AnomalyID 1810, type 1815, status 1820, and re-casted to count, shown as RTC 1825, indicating the number of anomalies that have been re-casted from this anomaly. Re-casting is discussed below. To assist the map maker in viewing anomalies, the map maker uses buttons, drop down boxes and hyperlinks in the anomaly list navigation area 1827. For example, the map maker can choose virtual buttons top 1830 to go to the top of the anomaly list, bottom 1831 to go to the bottom of the anomaly list, up 1832 to go one page up in the anomaly list, and down 1833 to go one page down in the anomaly list. The map maker can also group anomalies by their attributes using the group by drop down box 1834. The map maker can view a specific anomaly by typing an AnomalyID into a text box 1835 and clicking the go virtual button 1836. A map image 1850 is shown for the currently highlighted anomaly 1840, as well as further anomaly attribute information for this particular anomaly.

The anomaly browser application 1640 supports exporting anomalies and their associated attributes, shown as exporting 1644 from the anomaly repository 1614 in support of operational processes 1650 outside of the system. These processes include finding the appropriate geographic reference data to use in corroborating and resolving the anomalies. After users enter anomalies into the system, these anomalies are not resolved simply because users claim that geographic data errors exist. Thus, each anomaly is verified with geographic reference data from an appropriate reference resource. For example, the appropriate geographic reference data could be from a county government. Additional analysis of the data can also be performed outside the system. The system exports the anomalies and associated attributes to comma-delimited flat files containing, among other things, the map bounds of the original anomaly and the anomaly type. In FIG. 18, the map maker can use the export virtual button 1837 to export anomaly data to the operational processes 1650. In drop down box 1838, the map maker can select the format of the exported data, which is ISO-8859-1 in this example.

The anomaly browser application 1640 supports importing updates to anomaly attributes, shown as importing 1642, from operational processes 1650 into the anomaly repository 1614. Anomaly status values can be updated by importing a comma-delimited file created by automated processes running outside the system. In this manner, this file can be used to update the status of many anomalies at one time.

The anomaly browser application 1640 supports importing anomaly data, again shown as importing 1642, from operational processes 1650 directly into the anomaly repository 1614. This provides a method of entering anomaly data into the system from sources other than the CFL update reporting Web application 1245 in FIG. 12.

The anomaly browser application 1640 supports interactive validation of anomalies. Interactive validation is a process directed by a map technician and facilitated by the anomaly browser application, in which the technician examines an anomaly in detail using the latest available geographic data in the map maker's proprietary geographic database 1652 to determine whether or not the issue being reported exists in the database. Note that the version of geographic data used for validation can be newer than the geographic data 1295 on the CFL geo services servers 1275 used to support the place find service 1215 and the map service 1220.

Interactive validation is primarily used to statistically spot check the automatic validation agent 1632, as well as to validate anomalies for which the automatic validation agent 1632 is unable to make a determination.

The anomaly browser application 1640 supports interactive validation by emulating GPS devices The map maker can select an individual anomaly, and the anomaly browser application 1640 transmits the anomaly's location over a serial port, virtual or otherwise, via the National Marine Electronics Association 0183 (NMEA 0183) Standard. Other applications or devices, such as the geographic data viewer 1648, which support reading NMEA 0183 strings and which are designed to visualize geographic data can read this signal and “snap to” the specified location on a map. This process can then be used to compare geographic data, including the map maker's proprietary geographic database 1652, to the data reported with the anomaly in the anomaly repository 1614.

The anomaly browser application 1640 allows the map maker to re-cast anomalies which are either incorrectly formatted or which fail to specify sufficient information to make them actionable. The re-casting process is an interactive process directed by a map technician. The process creates a new anomaly from a user reported anomaly by copying most of the data from the source anomaly. The process allows the map technician to specify additional or changed data which can make the anomaly actionable. The number of anomalies created from a source anomaly via the re-casting process is shown in the anomaly browser application 1640 when the source anomaly is selected in the RTC column, shown as 1825 in FIG. 18.

The anomaly browser application 1640 can also be used to analyze business practices 1646. Analysis of large quantities of end user update requests could provide business intelligence about how the partners are using proprietary geographic data. Analysis of large quantities of end user update requests could also provide information about how effective certain projects conducted to improve the database have been.

Various agents, which are autonomous processes, also operate on the anomaly repository 1614. The agents operate continuously to analyze the anomalies and their attributes. The agents can update the anomaly repository 1614 with updated anomaly attributes 1618, as well as various forms of meta-data 1620, which is stored in the anomaly repository 1614.

FIG. 19 shows example statuses of anomalies, according to embodiments. An incident agent 1624 operates on the anomaly repository 1614 to update anomaly status. The incident agent 1624 operates only on anomalies that have been recently stored in the repository 1614 and that therefore have a status value of “Start” 1910. The incident agent 1624 is responsible for determining whether or not the anomaly is actionable, shown as “Actionable” 1915 and “Not Actionable” 1920, respectively. An anomaly is “Actionable” 1915 if it contains enough information for the map maker to determine whether or not the problem being reported represents a problem with the map maker's proprietary geographic database. Otherwise, the anomaly is “Not Actionable” 1920.

The incident agent 1624 makes the determination of whether an anomaly is actionable or not by examining the type and the map bounds reported in the anomaly. Some anomaly types are inherently not actionable. For example, anomalies about routing instructions are very difficult to tie back to specific data errors, so these anomalies are generally considered not actionable. By contrast, anomalies regarding incorrectly named streets are relatively easy to relate to the underlying geographic data, so these anomalies are generally considered actionable. In general, for an anomaly to be actionable, the map bounds must represent an appropriately precise geographic extent. While a misnamed street anomaly is not actionable when paired with a map of the state of Vermont, it is very actionable when accompanied by a zoomed-in map of limited geographic extent.

The incident agent 1624 updates the status of the anomalies it examines to either “New” 1925, meaning the anomaly is actionable, or “BadIncident” 1930, meaning the anomaly is not actionable. Although anomalies with a status of “BadIncident” 1930 are not individually actionable, in aggregate they can prove useful in informing the map maker about the map's data quality. For example, if a large number of routing anomalies are reported in a given city, the map maker can create a project to examine and improve the routing attribution in that area.

In FIG. 19, an automatic validation agent 1632 operates on the anomaly repository 1614. Alternatively, interactive validation is performed by the map maker using the anomaly browser application 1640, GPS emulation, and the geographic data viewer 1648. For convenience, operations of both the agent 1632 and application 1640 will be described in relation to the agent 1632. The automatic validation agent 1632 examines actionable anomalies that have a status value of “New” 1925, as well as anomalies with a status of “Open” 1935 that have been shown to be problems in the map maker's proprietary geographic database. For a “New” 1925 anomaly, the automatic validation agent 1632 attempts to determine whether the issue reported actually exists in the map maker's database. For example, if the anomaly in question is a misnamed street, the automatic validation agent 1632 might locate that street in the latest version of the map maker's database and compare the name of the street to the name reported by the end user.

For a “New” 1925 anomaly, if the anomaly appears to correctly describe a problem in the map maker's database, the anomaly is considered to be “Valid” 1940, and the anomaly's status value is set to “Open” 1935. If the anomaly does not appear to correctly describe a problem in the map maker's database, the anomaly is considered to be “Invalid” 1945, and the anomaly's status value is set to “Closed” 1950. If it is difficult or impossible to determine whether or not the anomaly appears to correctly describe a problem in the map maker's database, the anomaly is considered to be “Unclear” 1955, and the automatic validation agent leaves the anomaly's status unchanged as “New” 1925. For an anomaly with a status of “Open” 1935, if the issue reported appears to be correct in the map maker's database, then “Corrective Action” 1960 has been taken, and the anomaly's status is set to “Closed” 1950.

The automatic validation agent periodically examines both “New” 1925 anomalies, which are newly reported actionable anomalies and “Open” 1935 anomalies that have been determined to be problems in the map maker's database. In this manner, the agent discovers when anomalies have been addressed by the map maker's corrective actions and avoids direct linkage between updates to the geographic database and anomaly status changes. The geographic data used for automatic validation can be newer than the geographic data supporting the place find service 1215 and map service 1220 on the CFL Web services server 1270.

A case generation agent 1628 operates on the anomaly repository 1614 as shown in FIG. 16. The case generation agent 1628 attempts to identify multiple update reports that reference an identical real world issue. In short, it identifies duplicate anomalies. The methods for identifying duplicate anomalies vary widely from anomaly type to type. For anomaly types that occur at a single point, such as turn restrictions, the map center and bounds are likely to be given priority when determining duplicates. For anomaly types that occur over a wider geographic area, such as misnamed street, the supplemental data, such as the street name, can take priority.

When the case generation agent 1628 detects duplicate anomalies, the agent creates a piece of meta-data 1620 referred to a case and adds each anomaly to that case. Thus, a case contains a number of anomalies which constitute that case. The count of anomalies in a case can represent an operational priority. For example, if five hundred existing reports indicate a certain street is misnamed, the street is very likely misnamed and the issue should be given priority when updating the map maker's database.

The case generation agent 1628 is an autonomous process that derives operational intelligence from the raw anomaly data. This operational intelligence can be used to inform operational processes designed to maximize the map maker's ability to update the geographic database.

The clustering agent 1630 is similar to the case generation agent 1628 and also operates on the anomaly repository 1614. The clustering agent 1630 examines anomalies and identifies locations where similar anomalies appear in meaningful proximity to each other. When the agent identifies these anomalies, the agent creates a type of meta-data 1620 called a cluster and adds each anomaly to that cluster. Thus, a cluster contains a number of anomalies which constitute that cluster. In some embodiments, the number of anomalies in a cluster can represent an operational priority. For example, if the clustering agent identifies a large number of issues related to highway exits along a given path, these issues should be given priority when updating the map maker's database.

The clustering agent 1630 is an autonomous process that derives operational intelligence from the raw anomaly data. This operational intelligence can be used to inform operational processes designed to maximize the map maker's ability to update the geographic database.

Other agents include the email agent 1622 which notifies end users who have supplied email addresses of various events in the processing of their anomalies, as well as the geographic augmentation agent 1626 which, based on an anomaly's map bounds, augments the anomaly's attributes with geographical attributes such as the country.

Other applications include a variety of health reports that are created and used internally by the map maker. These health reports include an incident agent health report 1670, an email agent health report 1672, a geographic augmentation health report 1674, and a collection service health report 1676. These health reports operate in a similar manner by examining the anomaly repository 1614 to confirm that each of the agents, incident agent 1624, email agent 1622, geographic augmentation agent 1626, as well as the anomaly collection service 1225 in the CFL front end 1210, have processed the most recent anomalies written to the repository. These health reports are implemented as web applications which report on the status of each of the agents.

The CFL back end 1610 also includes a reporting repository 1660 to facilitate reporting, both internally to company management and externally to partners. The reporting repository 1660 contains a subset of the full anomaly repository 1614 data and is periodically updated from the anomaly repository. Data in the reporting repository 1660 is available in a more convenient view for reporting than the data in anomaly repository 1614. These internal reports to the company management and external reports to partners are created internally by the map maker by using a reporting application 1662. The reports include information describing progress analyzing and acting on end user reports.

### Scalability and Robustness

The system architecture is designed to facilitate scalability with regard to the number of anomalies collected. There can be many instances of the CFL update reporting Web application 1245, and indeed even different applications 1245, as long as they communicate according to the CFL Web services API 1240, utilizing an arbitrary number of CFL Web service servers 1270. These various Web service servers 1270 will contain different sets of anomalies, which are then funneled to the single central anomaly repository 1614.

The system is also designed to tolerate networking problems. If the Web service servers 1270 are unable to communicate with the catcher service 1612, the collected anomalies simply accumulate in the collection database 1250. Such a failure could be tolerated for extended periods. Once network connectivity is restored, the thrower application 1255 will simply have a long list of anomalies to transfer to the catcher service 1612. The only cost to such an outage is increased transfer time between end user submission and the data being placed in the anomaly repository 1614 for analysis.

### Closing the Loop: The End User Feedback Process

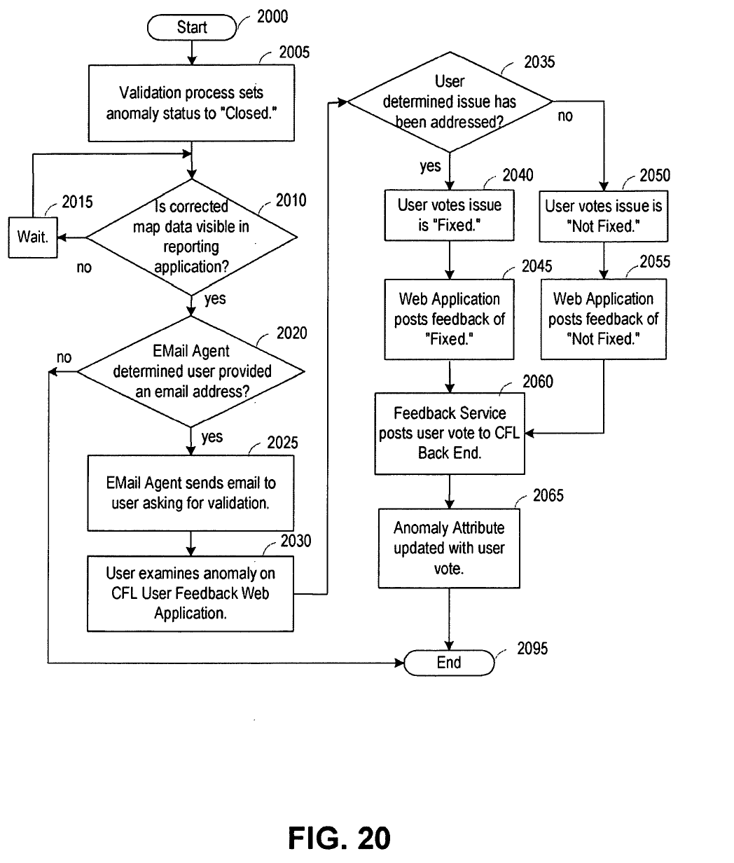

FIG. 20 shows an example flow chart of the end user feedback process, according to embodiments. This process starts at step 2000. In step 2005, the status of the anomaly is set to “Closed” either through the automatic validation agent 1632 or through the interactive validation by a map technician using the anomaly browser application 1640. At this point, the map maker believes that the anomaly has been addressed and the corrective action has been integrated into the proprietary geographic database 1652.

In step 2010, if a version of the database containing the corrective action has not been created and made available to the CFL place find service 1215 and map service 1220 in geographic data 1295, the process waits a period of time in step 2015 before repeating the database version check. In step 2010, if a version of the database containing the corrective action has been created and made available to the CFL place find service 1215 and map service 1220 in geographic data 1295, then in step 2020, the email agent 1622 determines if the anomaly contains an email address.

In step 2020, if the anomaly does not contain an email address, then the anomaly status can not be emailed to the end user, and the process ends in step 2095. In step 202, if the anomaly contains an email address, then in step 2025 the Email Agent sends an email to the end user suggesting that they use the CFL end user feedback Web application 1265 to verify that the anomaly he or she reported has been addressed.

In step 2030, the end user utilizes the feedback Web application 1265 to determine if the updated geographic data addresses the issue he or she originally reported. In step 2035, if the user determines that the issue has been addressed properly, in step 2040 the user votes that the issue is “Fixed.” In step 2045, the feedback Web application 1265 posts this information to the feedback database 1280 in the feedback web service 1230, indicating that the user voted the anomaly associated with the issue is “Fixed.”

In step 2035, if the user determines that the issue has not been properly addressed, in step 2050 the user votes the issue is “Not Fixed.” In step 2055, the feedback Web application 1265 posts this information to the feedback database 1280 in the feedback Web service 1230, indicating that the user voted the anomaly associated with the issue is “Not Fixed.”

In step 2060, the feedback service 1230 transfers the end user “vote” back to the CFL back end 1610, using a technique similar to that of the thrower application 1255 and catcher service 1612. In step 2065, the CFL back end 1610 updates one of the anomaly's attributes 1618 to indicate whether or not the user believes the anomaly to be fixed. The process ends in step 2095.

In embodiments, the map maker does not contact the end user directly but rather notifies the end users via partners who wish to maintain the customer relationship with the end users. In this case, an anomaly's unique tracking number, issued to the partner when the anomaly was submitted, serves to connect the end user and the anomaly. The partner can build their own feedback Web application to contact end users. The partner application could use the feedback service 1230, however, to communicate end user's “votes” to the CFL back end 1610.

### System Advantages

The system supports the automatic processing of end user geographic data update requests because the user and partner update requests are collected as structured data in a language neutral manner. The system can describe the type of a problem and the location of a problem in a manner that an automated process can recognize. The type of the end user geographic data update request is described using enumerated values, implemented as a set of string constants, such as “MissingAddress” or “MisnamedStreet,” as well as structured data description fields, for example, a correct name field in which the user enters the correct name of a misnamed street. The location of the problem is expressed by a geographic extent, specified by two pair of latitude/longitude coordinates that define a rectangular area in space. The enumerated values, structured data fields and geographic extents are language neutral and thereby avoid any dependency on translation. Given these structured elements, the system can automatically group and analyze these incidents to determine trends or problem areas. The system can use automated processes to address large quantities of these incidents to efficiently prioritize updates to the proprietary geographic database.

Analysis of large quantities of end user update requests could provide business intelligence about how the partners are using proprietary geographic data. Analysis of large quantities of end user update requests could also provide information about how effective certain projects conducted to improve the database have been.

The system supports “closing the loop” with the end user to ask them to confirm or deny that the proprietary geographic database contains a fix for the issue they reported. By knowing whether the end user, who originally reported the problem, believes that the database is now correct, the map maker can have confidence that the problem is indeed addressed.

By structuring the system as a loosely coupled distributed system, the system is enabled to scale as the quantity of user update requests grows. The system includes components designed to support the collection of user update requests which are very loosely coupled to the back-end systems that support analysis and processing. Should the volume of data submissions grow significantly, these components can be replicated to meet the need without affecting the rest of the system.

This toolset allows the end user supplied data to be transformed into information to guide proprietary database production processes and business planning processes.

### System Hardware, Software, and Components

Embodiments of the present invention can include computer-based methods and systems which can be implemented using a conventional general purpose or a specialized digital computer(s) or microprocessor(s), programmed according to the teachings of the present disclosure. Appropriate software coding can readily be prepared by programmers based on the teachings of the present disclosure.

Embodiments of the present invention can include a computer readable medium, such as a computer readable storage medium. The computer readable storage medium can have stored instructions which can be used to program a computer to perform any of the features presented herein. The storage medium can include, but is not limited to, any type of disk including floppy disks, optical discs, DVDs, CD-ROMs, microdrives, and magneto-optical disks, ROMs, RAMs, EPROMs, EEPROMs, DRAMs, flash memory or any media or device suitable for storing instructions and/or data. The present invention can include software for controlling both the hardware of a computer, such as a general purpose/specialized computer(s) or microprocessor(s), and for enabling them to interact with a human user or other mechanism utilizing the results of the present invention. Such software can include, but is not limited to, device drivers, operating systems, execution environments/containers, user interfaces, and user applications.

Embodiments of the present invention can include providing code for implementing processes of the present invention. The providing can include providing code to a user in any manner. For example, the providing can include transmitting digital signals containing the code to a user; providing the code on a physical media to a user; or any other method of making the code available.

Embodiments of the present invention can include a computer implemented method for transmitting the code which can be executed at a computer to perform any of the processes of embodiments of the present invention. The transmitting can include transfer through any portion of a network, such as the Internet; through wires, the atmosphere or space; or any other type of transmission. The transmitting can include initiating a transmission of code; or causing the code to pass into any region or country from another region or country. A transmission to a user can include any transmission received by the user in any region or country, regardless of the location from which the transmission is sent.

Embodiments of the present invention can include a signal containing code which can be executed at a computer to perform any of the processes of embodiments of the present invention. The signal can be transmitted through a network, such as the Internet; through wires, the atmosphere or space; or any other type of transmission. The entire signal need not be in transit at the same time. The signal can extend in time over the period of its transfer. The signal is not to be considered as a snapshot of what is currently in transit.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps performed in the embodiments of the invention disclosed can be performed in alternate orders, certain steps can be omitted, and additional steps can be added. It is to be understood that other embodiments of the invention can be developed and fall within the spirit and scope of the invention and claims. The embodiments were chosen and described in order to best explain the principles of the invention and its practical application, thereby enabling others of ordinary skill in the relevant arts to understand the invention for various embodiments and with various modifications that are suited to the particular use contemplated. It is intended that the scope of the invention be defined by the following claims and their equivalents.

1-13. (canceled)

14. A method to improve geographic data utilized by a plurality of users of navigations systems, the method comprising the following steps:
obtaining, from a user of a navigation system, the user's identification of a location of an anomaly, the identification being in language-neutral structured data, wherein the anomaly comprises a geographic inconsistency between geographic data and the real world;
obtaining, from the user of the navigation system, the user's description of the anomaly, the user's description of the anomaly being in language-neutral structured data;
categorizing the anomaly according to at least one of location and type; and
determining a priority of anomalies to correct based on an analysis of a plurality of categorized anomalies.
